(19) United States
(12) Patent Application Publication
(10) Pub. No.: US 2009/0283930 A1
(43) Pub. Date: Nov. 19, 2009

(54) METHOD FOR MANUFACTURING THERMOPLASTIC RESIN FILM

(76) Inventor: Akihide Fujita, Fujinomiya-shi (JP)

Correspondence Address: SUGHRUE MION, PLLC, 2100 PENNSYLVANIA AVENUE, N.W., SUITE 800, WASHINGTON, DC, 20037, US

(21) Appl. No.: 12/094,567

(22) PCT Filed: Nov. 20, 2006
(86) PCT No.: PCT/JP2006/323526

§ 371 Date: Aug. 4, 2008

(30) Foreign Application Priority Data
Nov. 22, 2005 (JP) 2005-337587
Nov. 2, 2006 (JP) 2006-299466

(51) Int. Cl. B29C 67/00; B29C 47/08

(52) U.S. Cl. 264/175

(57) ABSTRACT

An aspect of the present invention is a method for manufacturing a thermoplastic resin film, comprising the steps of: extruding a molten thermoplastic resin from a die in the form of sheet; and sandwiching the sheet-form thermoplastic resin between one support and the other support, wherein at least one of the supports has such a surface property that the arithmetic average surface depth (Ra) is 100 nm or less, and the support is a hollow drum and the thickness Z (mm) of an outercylinder of the drum satisfies the following expression; 0.2 mm<Z (mm)<7.0 mm. According to the aspect, the thickness-direction retardation (Rth) of a thermoplastic resin film can be controlled.

### TECHNICAL FIELD

The present invention relates to a method for manufacturing a thermoplastic resin film, and more specifically, to a method for manufacturing a thermoplastic resin film preferably used as a substrate of optical films.

### BACKGROUND ART

A thermoplastic resin film such as a cellulose acylate film is obtained by melting and extruding a thermoplastic resin by an extruder into a die, ejecting the molten thermoplastic resin from an ejection port in the form of sheet (hereinafter referred to as a “sheet-form molten resin”), casting it between two metallic touch rolls, followed by cooling to solidify. This is called as a “melt-film formation method.” Thereafter, the film is drawn in at least one of the longitudinal direction (machine direction (MD)) and the transverse direction (TD) to obtain a film having desired in-plane retardation (Re) and a thickness-direction retardation (Rth). This film is used as an optical compensation film (also referred to as a “phase contrast film”) of a liquid crystal display device for magnifying a viewing angle (for example, see National Publication of International Patent Application No. 6-501040).

In recent years, liquid crystal displays have been mainstream displays used in thin televisions. Liquid crystal displays, however, have a drawback that their display quality is lowered at tilt view angle. In order to improve the viewing angle of LCDs, the retardation films using liquid crystal described above have been used in LCDs. And IPS (In-Plane-Switching)-mode and VA-mode LCDs, in which the characteristics of liquid crystal orientation have been changed, have also been developed. Particularly in IPS-mode LCDs, liquid crystal molecules respond only in the direction parallel to the glass substrate surface. Such liquid crystal orientation in plane alone allows IPS-mode LCDs to have excellent viewing characteristics.

### DISCLOSURE OF THE INVENTION

### Problems to be solved by the Invention

However, to make use of the characteristics of liquid crystal orientation to produce high display quality, it is necessary to control the birefringence across the depth (i.e. thickness-direction retardation; Rth) of the sheets of polarizer, which are laminated on the surfaces of the glass substrates opposite to the surfaces between which the liquid crystal molecules are held.

Accordingly, an object of the present invention is to provide a method for manufacturing a thermoplastic resin film having a controlled thickness-direction retardation (Rth).

### Means for Solving the Problems

To achieve the above object, a first aspect of the present invention is a method for manufacturing a thermoplastic resin film, comprising the steps of: extruding a molten thermoplastic resin from a die in the form of sheet; and sandwiching the sheet-form thermoplastic resin between one support and the other support to cool the supports, wherein at least one of the supports has such a surface property that the arithmetic average surface depth (Ra) is 100 nm or less, and the support is a hollow drum and the thickness Z (mm) of an outercylinder of the drum satisfies the following expression; 0.2 mm<Z (mm)<7.0 mm. According to the first aspect, the thickness-direction retardation (Rth) of a thermoplastic resin film can be controlled.

According to a second aspect of the present invention is the method for manufacturing a thermoplastic resin film according to the first aspect, it is preferable that the ratio (P/Q) of the line pressure P (kg/cm) of the sheet-form thermoplastic resin sandwiched between the one drum and the other drum and the length Q (cm) of the one support in contact with the other support via the sheet-form thermoplastic resin interposed therebetween satisfies 50 kg/cm²<(P/Q)<200 kg/cm².

According to a third aspect of the present invention is the method for manufacturing a thermoplastic resin film according to the first or second aspect, it is preferable that a manufacturing speed Y (m/min) of the thermoplastic resin film satisfies the following equation: 0.0043X²+0.1236X+1.1357<Y(m/min)<0.0191X²+0.7316X+24.005; where T1 (° C.) represents the solid-solid phase transition temperature of the thermoplastic resin, T2 (° C.) represents the temperature of at least one of the supports, and X(° C.) represents (T1−T2), which is a temperature difference between T1 and T2. According to a fourth aspect of the present invention is the method for manufacturing a thermoplastic resin film according to the third aspect, it is preferable that the solid-solid phase transition temperature (° C.) of the thermoplastic resin is equal to the glass transition temperature Tg (° C.) of the thermoplastic resin.

According to a fifth aspect of the present invention is the method for manufacturing a thermoplastic resin film according to any one of the first to fourth aspects, it is preferable that the length Q (cm) of the one support in contact with the other support via the sheet-form thermoplastic resin is 0.5 cm to 2.5 cm (both inclusive). According to a sixth aspect of the present invention is the method for manufacturing a thermoplastic resin film according to any one of the first to fifth aspects, it is preferable that the temperature T0 (° C.) of the sheet-form thermoplastic resin before it is sandwiched between the one support and the other support is 45° C. to 160° C. (both inclusive). According to a seventh aspect of the present invention is the method for manufacturing a thermoplastic resin film according to any one of the first to sixth aspects, it is preferable that at least one of the supports is an elastic roll made of a metal.

According to an eighth aspect of the present invention is the method for manufacturing a thermoplastic resin film according to any one of the first to seventh aspects, it is preferable that the thermoplastic resin is a cellulose acylate resin. According to a ninth aspect of the present invention is the method for manufacturing a thermoplastic resin film according to eighth aspect, it is preferable that the cellulose acylate resin has a number average molecular weight of 20,000 to 80,000 and the substitutions degree of the acyl groups satisfies following equations:

2.0≦A+B≦3.0,

0≦A≦2.0,

1.2≦B≦2.9,

where A represents the substitution degree of acetyl groups and B represents the sum of substitution degrees of acyl groups having 3 to 7 carbon atoms.

According to a tenth aspect of the present invention is the method for manufacturing a thermoplastic resin film according to any one of the first to ninth aspects, it is preferable that the temperature of at least one of the supports is adjusted to 45° C. to 160° C. (both inclusive). According to an eleventh aspect of the present invention is the method for manufacturing a thermoplastic resin film according to any one of the first to tenth aspects, it is preferable that at least one of the supports is a roll or a belt. According to a twelfth aspect of the present invention is the method for manufacturing a thermoplastic resin film according to any one of the first to eleventh aspects, it is preferable that a zero shear viscosity of the thermoplastic resin ejected from the die is 2000 Pa·s or less. According to a thirteenth aspect of the present invention is the method for manufacturing a thermoplastic resin film according to any one of the first to twelfth aspects, it is preferable that the zero shear viscosity of the thermoplastic resin at 230° C. measured by plate-cone viscometry is 50 Pa·s to 2000 Pa·s (both inclusive).

According to a fourteenth aspect of the present invention is the method for manufacturing a thermoplastic resin film according to any one of the first to thirteenth aspects, it is preferable that the in-plane retardation (Re) of the thermoplastic resin film is 20 nm or smaller. According to a fifteenth aspect of the invention, it is preferable that the thermoplastic resin film produced has a thickness-direction retardation (Rth) of 20 nm to 200 nm (both inclusive). According to a sixteenth aspect of the present invention, it is preferable that a drawing step for drawing the sheet-form thermoplastic resin or thermoplastic resin film in an arbitrary direction is included.

According to seventeenth to nineteenth aspects, it is preferable to produce a thermoplastic resin serving as a substrate of an optical compensation film, a polarizing film of a sheet polarizer or an anti-reflective film.

### ADVANTAGES OF THE INVENTION

According to the method for manufacturing a thermoplastic resin film of the present invention, a thermoplastic resin film having a controlled thickness-direction retardation (Rth value) can be obtained.

### BRIEF DESCRIPTION OF THE DRAWINGS

FIG. 1 is a schematic diagram of a production line for producing a film according to the present invention;

FIG. 2 is an enlarged view of the gist portion of FIG. 1; and

FIG. 3 is a schematic view of the gist portion of the production line for producing a film according to another embodiment of the present invention.

### DESCRIPTION OF SYMBOLS

10 . . . Film production line
17 . . . Casting drum
18 . . . Elastic drum
41 . . . Cellulose acylate
42 . . . Cellulose acylate film

### BEST MODE FOR CARRYING OUT THE INVENTION

Preferable embodiments of a thermoplastic resin film formation method according to the present invention will be explained. In the embodiments, examples of producing a cellulose acylate film will be explained; however the present invention will not be limited to the examples and applicable to a method for manufacturing a film from a thermoplastic resin (such as a cellulose-based resin) other than cellulose acylate. In the following, the method for manufacturing a thermoplastic resin film of the present invention will be described in terms of the embodiment where the one support and the other support is a casting drum and an elastic drum.

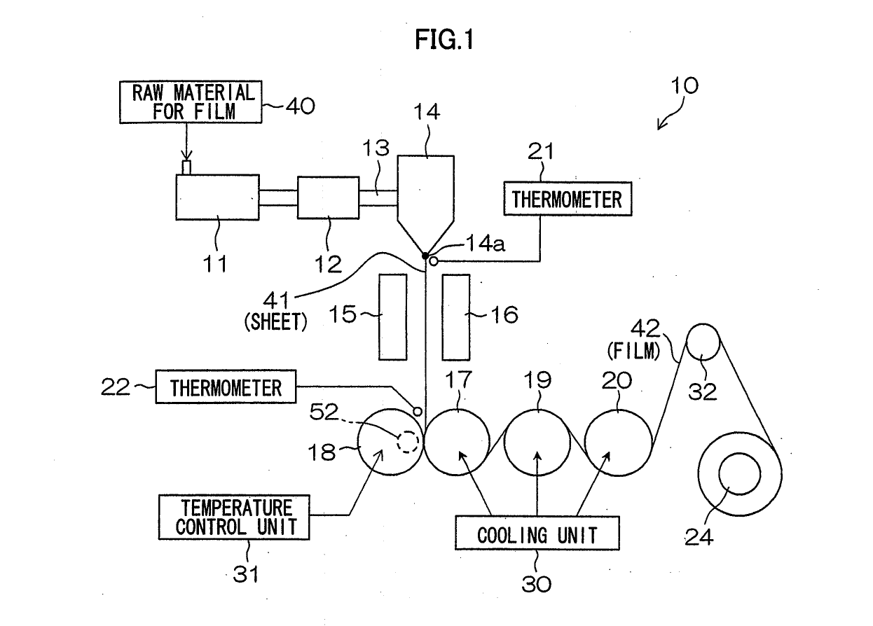

FIG. 1 shows a schematic structure of a film production line 10 (hereinafter referred to also as a “production line”) of a cellulose acylate film. The production line 10 is constituted of an extruder 11, a gear pump 12, a pipe 13, a die 14, heaters 15,16, casting drum 17, elastic drum 18, cooling drums 19,20, thermometers 21,22, and a winder 24, etc. A film material 40 containing cellulose acylate as a main component is supplied from a hopper (not shown) to the extruder 11 and melted in the extruder 11 to obtain molten cellulose acylate. Preferably the cellulose acylate in the film raw material 40 used in the present invention has a zero shear viscosity at 230° C., when measured by corn and plate viscometry, of 50 Pa·s to 2000 Pa·s (both inclusive), more preferably 50 Pa·s to 1200 Pa·s (both inclusive), and most preferably 50 Pa·s to 800 Pa·s or lower (both inclusive). The zero shear viscosity lower than 50 Pa·s is not preferable in that the uniformity of film surface is hard to ensure, whereas the zero shear viscosity higher than 2000 Pa·s is not preferable in that the load on the filtration process is increased.

The extrusion temperature, which is the temperature of the molten cellulose acylate extruded from the extruder 11, is preferably 190° C. to 240° C. (both inclusive), more preferably 195° C. to 235° C. (both inclusive), and particularly preferably, 200° C. to 230° C. (both inclusive). If the extrusion temperature is less than 190° C., melting of a cellulose acylate crystal sometimes comes to be insufficient. As a result, fine crystals are likely to remain in the cellulose acylate film obtained. Even if such a cellulose acylate film is drawn, the drawing is inhibited and the orientational ordering of cellulose acylate molecules cannot be controlled sufficiently and desired retardation values (Re and Rth) cannot be obtained in some cases. In other cases, breakage of the cellulose acylate film may occur. On the other hand, if the extrusion temperature exceeds 240° C., deterioration such as thermolysis of the cellulose acylate film may occur.

The molten cellulose acylate is fed by the gear pump 12 into the die 14 through the pipe 13. Note that, it is preferable that the pipe 13 is equipped with a thermal control unit (not shown) to keep the pipe 13 at a predetermined temperature.

The molten cellulose acylate is ejected from the die 14 in the form of sheet. The sheet-form cellulose acylate film (hereinafter referred to as a “cellulose acylate sheet” 41) is cast between the casting drum 17 and the elastic drum 18. The position at which the cellulose acylate sheet is cast between the casting drum 17 and the elastic drum 18 is hereinafter referred to as a “casting position.” The zero shearing viscosity of the molten cellulose acylate ejected from the outlet 14a of the die is preferably set at 2000 Pa·s or less, more preferably 1200 Pa·s or less, and most preferably, 800 Pa·s or less. The lowermost value is not particularly limited and preferably 50 Pa·s or more in view of melting stability of the resin ejected from the die during melting/forming a film. Note that, the zero shearing viscosity used herein is obtained as follows. First, melting viscosity is measured by a plate-cone type melting-viscosity measuring device while changing a shearing rate to obtain data showing the dependency of a melting viscosity upon a shearing rate. The melting viscosity at the zero shearing rate can be obtained by extrapolating melting viscosity at a zero shearing rate from the measurement value in the range of the melting viscosity independent of the shearing rate. It is advantageous to set the zero shearing viscosity at the outlet 14a of the die within the aforementioned range, since the film formed by melting has a thickness accuracy improved and an excellent surface state.

To maintain the temperature of the cellulose acylate sheet 41 at a desired temperature, heaters 15, 16 are preferably arranged on at least one side of the cellulose acylate sheet 41, and more preferably heaters 15, 16 are arranged at the both sides, as shown in FIG. 1. The temperature of the heaters 15, 16 is preferably 100° C. to 500° C. (both inclusive), more preferably 180 to 400° C. (both inclusive), and most preferably, 200° C. to 350° C. (both inclusive).

The cooling drums 19,20 are provided downstream of the casting drum 17. Although two cooling drums are provided in FIG. 1; however the number of cooling drums is not limited to two in the present invention. A cooling unit 30 is independently connected to each of the drums 17,19,20 to control the temperature of each of the drums 17,19,20 separately. The elastic drum 18 is provided so as to face the casting drum 17 with the cellulose acylate sheet 41 interposed therebetween them. The elastic drum 18 is preferably equipped with a temperature control device 31 also to control the temperature of the elastic drum 18. Alternatively, the temperature of the elastic drum 18 may be controlled by the cooling unit 30. The temperature of each drum 17-20 is not particularly limited; however, the temperature of the casting drum 17 is preferably 45° C. to 160° C. (both inclusive), more preferably 60° C. to 140° C. (both inclusive), and most preferably, 75° C. to 130° C. (both inclusive). The temperature of the elastic drum 18 is preferably 45° C. to 160° C. (both inclusive), more preferably 60° C. to 140° C. (both inclusive), and most preferably, 75° C. to 130° C. (both inclusive). The temperature of the cooling drums 19, 20 is preferably 60° C. to 150° C. (both inclusive), more preferably 75° C. to 140° C. (both inclusive), and most preferably, 90 to 130° C. (both inclusive). The cellulose acylate sheet 41 is cooled on the surfaces of the drums. The cellulose acylate sheet 41 cooled is hereinafter referred to as a “cellulose acylate film 42.”

Then, the cellulose acylate film 42 is transferred while being rolled by the roller 32. Finally, the cellulose acylate film 42 is wound up by the winder 24 into a roll.

In the present invention, the film formation rate of the cellulose acylate film 42 is not particularly limited; however, preferably 1 m/minute to 300 m/minute (both inclusive), more preferably 10 n/minute to 150 n/minute (both inclusive), and more preferably 15 m/minute to 120 m/minute (both inclusive). A method for manufacturing a cellulose acylate film 42 according to the present invention is preferably employed to forming a film having an average film-thickness of 200 μm to 300 μm (both inclusive), more preferably 30 μm to 200 μm (both inclusive), and most preferably, 40 μm to 100 μm (both inclusive).

In the present invention, preferably the elastic drum 18 has an arithmetic average surface depth (=arithmetic average surface roughness; Ra) of 100 nm or smaller, more preferably 50 nm or smaller, and most preferably 25 nm or smaller.

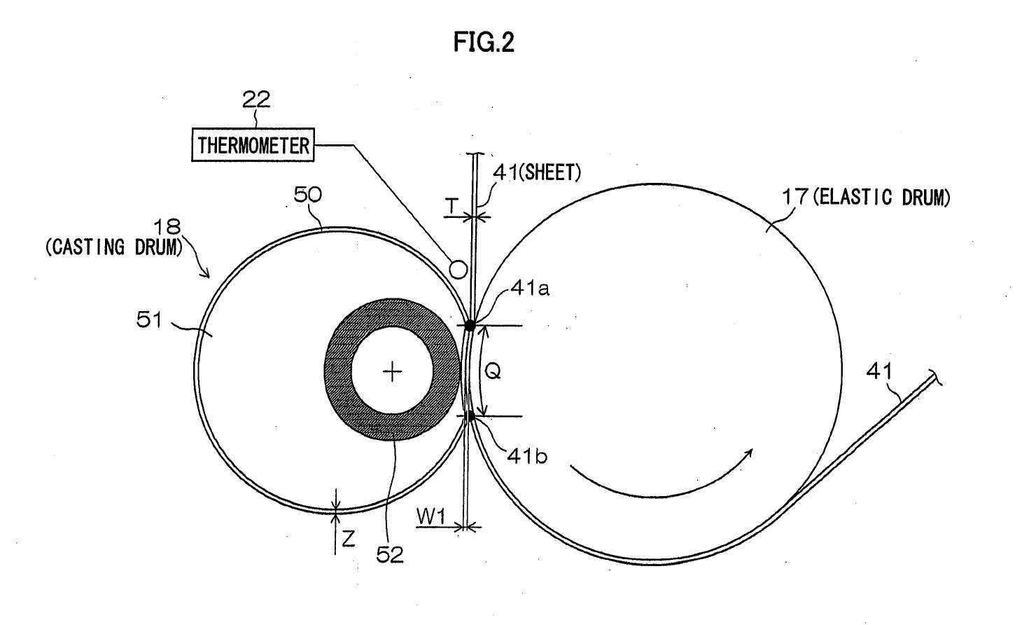

The cross-sectional view of the elastic drum 18 is shown in FIG. 2. The elastic drum 18 is made up of: metal the shell 50 (also referred to as outer cylinder); the fluid 51 filled into the shell 50; and the resin top 52 arranged in the fluid 51. The elastic drum 18 and the resin top 52 are rotated by the rotation of the casting drum 17 which is in contact with them via the cellulose acylate sheet 41. Such construction is preferable from the viewpoint of cooling the cellulose acylate sheet 41. Examples of the fluid 51 preferably used include, not limited to, water. Examples of the materials for the resin top 52 include, not limited to, nitrile rubber. The thickness Z (mm) of the shell 51 as the outer cylinder of the elastic drum 18 is preferably in the following range, 0.2 mm<Z (mm)<7.0 mm and more preferably 0.5 mm<Z (mm)<5.0 mm. Thickness Z of the shell 51 0.2 mm or smaller might make it impossible to apply a desired line pressure (described later) to the cellulose acylate sheet 41. Conversely, thickness Z 7.0 mm or larger might create excess stress in the cellulose acylate sheet.

The solid-phase to solid-phase transition temperature of a thermoplastic resin, which is a main raw material of a thermoplastic resin film according to the present invention, is represented by T1(° C.). As a representative example of the solid-phase to solid-phase transition temperature, mention may be made of a glass transition temperature Tg (° C.) of the thermoplastic resin. Furthermore, the temperature of the elastic drum 18 is represented by T2 (° C.). The difference in temperature (T1−T2) is represented by X(° C.). In this case, provided that a formation speed of the cellulose acylate film 42 is represented by Y(m/min), Y satisfies preferably the relationship, more preferably the relationship, and most preferably the relationship below;

0.0043X²+0.1236X+1.1357<Y (m/min)<0.0191X²+0.7316X+24.005

0.065X²+0.185X+1.704<Y (m/min)<0.1624X²+0.6219X+20.404

0.086X²+0.247X+2.271<Y (m/min)<0.1337X²+0.5121X+16.804

Note that the formation rate Y(m/min) of the cellulose acylate film 42 refers to a speed of film forming step for the cellulose acylate film 42 in the case where no drawing unit is performed.

The stress generated when the cellulose acylate sheet 41 is sandwiched between the casting drum 17 and the elastic drum 18 is designated as line pressure P (kg/cm). The length of the contact line between the casing drum 17 and the elastic drum 18 with the cellulose acylate sheet 41 interposed therebetween them is represented by Q (cm). The length Q (cm) means the length between a contact initiation point 41a, at which the cellulose acylate sheet 41 is allowed in contact with the elastic drum 18 and a contact termination point 41b, at which the cellulose acylate sheet 41 removes from the elastic drum.

In the present invention, the ratio of line pressure P to length Q preferably satisfies the relationship, more preferably the relationship, and most preferably, the relationship below:

50 kg/cm²<(P/Q)<200 kg/cm²,

52 kg/cm²<(P/Q)<100 kg/cm²,

55 kg/cm²<(P/Q)<75 kg/cm².

The length Q (cm) is preferably 0.5 cm to 2.5 cm (both inclusive), more preferably 1.0 cm to 2.0 cm (both inclusive), and most preferably 1.25 cm to 1.75 cm (both inclusive).

After intensive investigation, the present inventors have found that the thickness-direction retardation value (Rth value) of the resultant cellulose acylate film 42 can be controlled by controlling the length (Q). The inventors have also found a method for controlling the maximum proximity distance W1 (μm) between the casting drum 17 and the elastic drum 18, though there are various possible methods for controlling the length Q (cm) and the method is not limited to any specific one. The length Q (cm) can also be controlled by connecting a cylinder (not shown in the figure) to each of the drums 17, 18 and adjusting the pressure for pressing the cylinder.

If the adjusting step, in which at least one of the length Q (cm) and the line pressure P (kg/cm) is adjusted, and the stretching step described later are properly combined, the thickness-direction retardation value (Rth value) can be adjusted to 20 nm to 200 nm (both inclusive). If conditions are selected more properly, Rth value can be adjusted to 20 nm to 800 nm (both inclusive). As described above, the most noticeable characteristic of the present invention is that the thickness-direction retardation value is adjusted by adjusting at least one of the length Q (cm) and the line pressure P (kg/cm) of the cellulose acylate sheet at the portion where the sheet comes in contact with the elastic drum while sandwiched between the casting drum and the elastic drum, when a film is manufactured by touch-roll melt film formation.

In the present invention, the casting drum 17 is preferably formed of a metal. Preferable examples of the metal include, but not limited to, SUS, nickel and chrome. As the cast drum 17, any one of drums having various shapes such as roll- or belt-shape can be used.

In the present invention, the cellulose acylate sheet 41 or the cellulose acylate film 42 may be subjected to a drawing unit such as transverse drawing (TD) and vertical drawing (MD). The drawing may be performed by a drawing machine (e.g., tenter type drawing machine) provided in the production line 10 or performed while feeding out the cellulose acylate film roll which has been wound up into a roll.

Desired retardation may be imparted to the cellulose acylate film 42 by the drawing unit.

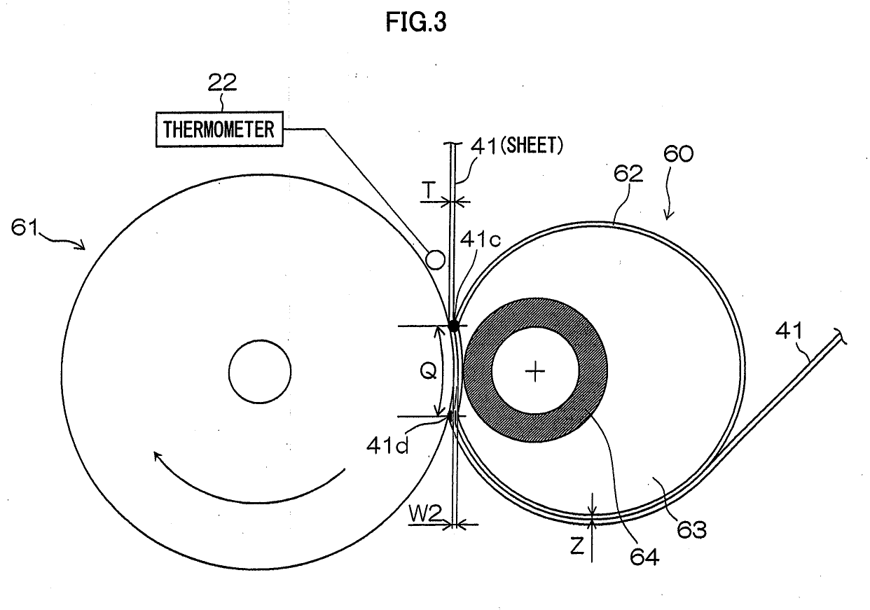

As shown in FIG. 3, an elastic drum may be used as a casting drum. This drum will be hereinafter referred to as a casting elastic drum 60. A casting-position adjusting drum 61 may be provided so as to face the casting elastic drum 60 with the cellulose acylate sheet 41 interposed therebetween them. The casting elastic drum 60 has a shell 62 formed of a metal such as SUS, nickel, or chrome and filled with fluid 63 (e.g., water), and has a spinning top 64 formed of a resin arranged therein. The casting elastic drum 60 and the spinning top 64 are rotated by rotation motion of the casting position adjusting drum 61 in contact with each other via the cellulose acylate sheet 41. Preferably the surface of the elastic casting drum 60 has an arithmetic average surface depth (Ra; arithmetic average surface roughness) of 100 nm or smaller, more preferably 50 nm or lower, and most preferably 25 nm or lower.

The thickness z (mm) of the shell 62 is preferably 0.2 mm to 7.0 mm (both inclusive), more preferably 0.5 mm to 5.0 mm (both inclusive). The temperature of the shell is preferably controlled at 45° C. to 160° C. (both inclusive). An embodiment of the casting position adjusting drum 61 is not particularly limited; however, preferably formed of a metal. The temperature of the casting position adjusting drum 61 is preferably controlled at 45° C. to 160° C. (both inclusive).

The length Q (cm) herein means the length between a contact initiation point 41c, at which the cellulose acylate sheet 41 is allowed in contact with the casting elastic drum 60, and a contact termination point 41d, at which the cellulose acylate sheet 41 removes from the casting elastic drum 60. Preferably the length Q (cm) is 0.5 cm to 2.5 cm (both inclusive), more preferably 1.0 cm to 2.0 cm (both inclusive), and most preferably 1.25 cm to 1.75 cm (both inclusive). As described above, the inventors have found that the length Q (cm) can be controlled by controlling the maximum proximity distance W2 (μm) between both the drums 60 and 61, though there are various possible methods for controlling the length Q (cm). The inventors have further found that the length Q (cm) can be controlled by connecting a cylinder to each of the drums 60, 61 and adjusting the pressure for pressing the cylinder. Accordingly the thickness-direction retardation value (Rth value) can be controlled, as described above.

The cellulose acylate film 42 obtained by the aforementioned method is preferably used as a base film (substrate) for a film for optical use such as an optical compensation film, polarizer, polarizing film or an anti-reflective film.

The cellulose acylate film rolled up can be drawn as described later. When the cellulose acylate film is drawn, the molecules of the cellulose acylate film are orientationally ordered to express in-plane retardation (Re) and thickness-direction retardation (Rth). The retardation Re and Rth can be obtained by the following equations.

Re (nm)=|n(MD)−n(TD)|×T (nm)

Rth (nm)=|{(n(MD)+n(TD))/2}−n(TH)|×T (nm)

where n(MD), n(TD), and n(TH) denote the refractive indexes in the longitudinal direction, width direction and thickness direction, respectively, and T (nm) denotes the thickness of a film.

A cellulose acylate film is first drawn in the longitudinal direction in a longitudinal drawing unit. In a longitudinal drawing unit, the cellulose acylate film is preheated and the cellulose acylate film thus heated is rolled over two nip rolls. Since the nip roll near the outlet rotates at a higher speed than the nip roll near the inlet, the cellulose acylate film is drawn in the longitudinal direction.

The cellulose acylate film longitudinally drawn is fed to a transverse drawing unit in which it is drawn in the width direction. In the transverse drawing unit, a tenter, for example, is preferably used. The cellulose acylate film is drawn transversely in the width direction by the tenter while holding both edges (in the width direction) of the cellulose acylate film by clips. The transverse drawing further increases retardation Rth.

By virtue of longitudinal and transverse drawing, drawn cellulose acylate film having retardation Re and Rth expressed therein can be obtained. A drawn cellulose acylate film preferably has Re from 0 nm to 500 nm (both inclusive), more preferably 10 nm to 400 nm (both inclusive), further preferably 15 nm to 300 nm (both inclusive), and has Rth from 30 nm to 500 nm (both inclusive), more preferably 50 nm to 400 nm (both inclusive), further preferably 70 nm to 350 nm (both inclusive). Of them, a drawn cellulose acylate film having Re and Rth which satisfies the relationship Re≦Rth is more preferable and satisfies the relationship Re×2≦Rth is further preferable. To attain high Rth and low Re, the cellulose acylate film is preferably first drawn longitudinally and then drawn transversely (in the width direction). The difference in orientation between the longitudinal direction and the transverse direction becomes the difference of retardation (Re). However, the difference of retardation, that is, in-plane retardation (Re), can be reduced by drawing not only in the longitudinal direction but also in the perpendicular direction, that is, the transverse direction, thereby reducing difference in the longitudinal orientation and the transverse orientation. On the other hand, drawing is performed not only in the longitudinal direction but also in the transverse direction, the area is enlarged and the thickness decreases. As the thickness decreases, the orientation of thickness direction increases, increasing Rth.

Furthermore, positional variations in Re and Rth in the width direction and the longitudinal direction are preferably 5% or less, more preferably 4% or less, and further preferably 3% or less. Furthermore, an orientation angle is preferably 90°±5° or 0°±5° or less, more preferably 90°±3° or 0°±3° or less, and further preferably 90°±1° or 0°±1° or less. When the drawing unit is performed as is in the present invention, bowing can be reduced. The bowing distortion is obtained as follows. First, a difference in distance is obtained between the center of a straight line drawn along the width direction on the surface of a cellulose acylate film before a drawing unit by a tenter and the center of a curved line (concave) after the drawing unit. The difference is divided by the width to obtain the bowing distortion. It is preferable that the bowing distortion is 10% or less, preferably 5% or less, and more preferably 3% or less.

Now, a method of synthesizing cellulose acylate suitable for the present invention and a method of synthesizing a cellulose acylate film will be explained in accordance with procedures.

(1) Plasticizer

It is preferable to add polyvalent alcohol based plasticizer to a polymer material for producing a cellulose acylate film according to the present invention. Such a plasticizer is effective in reducing not only elastic modulus and difference in crystal amount of upper and lower surfaces. The content of polyvalent alcohol based plasticizer is preferably 2% by mass to 20% by mass relative to cellulose acylate. The content of polyvalent alcohol based plasticizer is preferably 2% by mass to 20% by mass, more preferably 3% by mass to 18% by mass, and further preferably 4% by mass to 15% by mass. When the content of a polyvalent alcohol based plasticizer is less than 2% by mass, the aforementioned effects cannot be sufficiently obtained. On the other hand, when the content of a polyvalent alcohol based plasticizer is more than 20% by mass, the plasticizer precipitates (called as “bleeding”) on the surface of the film.

The polyvalent alcohol based plasticizer to be used in the present invention preferably has good compatibility with cellulose fatty acid ester and significantly exhibits thermo-plasticity. Examples of such a polyvalent alcohol based plasticizer include a glycerin based ester compounds such as glycerin ester and diglycerin ester, a polyalkylene glycol such as polyethylene glycol and polypropylene glycol, and a compound of polyalkylene glycol whose hydroxy group having an acyl group added thereto.

Specific examples of the glycerin ester include glycerin diacetate stearate, glycerin diacetate palmitate, glycerin diacetate myristate, glycerin diacetate laurate, glycerin diacetate caprate, glycerin diacetate nonanate, glycerin diacetate octanoate, glycerin diacetate heptanoate, glycerin diacetate hexanoate, glycerin diacetate pentanoate, glycerin diacetate oleate, glycerin acetate dicaprate, glycerin acetate dinonanate, glycerin acetate dioctanoate, glycerin acetate diheptanoate, glycerin acetate dicaproate, glycerin acetate divalerate, glycerin acetate dibutyrate, glycerin dipropionate caprate, glycerin dipropionate laurate, glycerin dipropionate myristate, glycerin dipropionate palmitate, glycerin dipropionate stearate, glycerin dipropionate oleate, glycerin tributyrate, glycerin tripentanoate, glycerin monopalmitate, glycerin monostearate, glycerine distearate, glycerin propionate laurate and glycerin oleate propionate. However, these are not limitative and may be used either alone or in combination thereof.

Among these, glycerin diacetate caprylate, glycerin diacetate pelargonate, glycerin diacetate caprate, glycerin diacetate laurate, glycerin diacetate myristate, glycerin diacetate palmitate, glycerin diacetate stearate and glycerin diacetate oleate are preferred.

Specific examples of the diglycerin esters include mixed acid esters of diglycerin such as diglycerin tetraacetate, diglycerin tetrapropionate, diglycerin tetrabutyrate, diglycerin tetravalerate, diglycerin tetrahexanoate, diglycerin tetraheptanoate, diglycerin tetracaprylate, diglycerin tetrapelargonate, diglycerin tetracaprate, diglycerin tetralaurate, diglycerin tetramyristate, diglycerin tetrapalmitate, diglycerintriacetate propionate, diglycerin triacetate butyrate, diglycerin triacetate valerate, diglycerin triacetate hexanoate, diglycerin triacetate heptanoate, diglycerin triacetate caprylate, diglycerin triacetate pelargonate, diglycerin triacetate caprate, diglycerin triacetate laurate, diglycerin triacetate myristate, diglycerin triacetate palmitate, diglycerin triacetate stearate, diglycerin triacetate oleate, diglycerin diacetate dipropionate, diglycerin diacetate dibutyrate, diglycerin diacetate divalerate, diglycerin diacetate dihexanoate, diglycerin diacetate diheptanoate, diglycerin diacetate dicaprylate, diglycerin diacetate dipelargonate, diglycerin diacetate dicaprate, diglycerin diacetate dilaurate, diglycerin diacetate dimyristate, diglycerin diacetate dipalmitate, diglycerin diacetate distearate, diglycerin diacetate dioleate, diglycerin acetate tripropionate, diglycerin acetate tributyrate, diglycerin acetate trivalerate, diglycerin acetate trihexanoate, diglycerin acetate triheptanoate, diglycerin acetate tricaprate, diglycerin acetate tripelargonate, diglycerin acetate tricaprate, diglycerin acetate trilaurate, diglycerin acetate trimyristate, diglycerin acetate tripalmitate, diglycerin acetate tristearate, diglycerin acetate trioleate, diglycerin laurate, diglycerin stearate, diglycerin caprylate, diglycerin myristate and diglycerin oleate. However, these are not limitative, and may be used either alone or in combination thereof.

Among these, diglycerin tetraacetate, diglycerin tetrapropionate, diglycerin tetrabutyrate, diglycerin tetracaprylate and diglycerin tetralaurate are preferred.

Specific examples of the polyalkylene glycols include polyethylene glycol and polypropylene glycol having a weight average molecular weight of from 200 to 1,000. However, there are not limitative, and may be used either alone or in combination thereof.

Specific examples of the compounds in which an acyl group is bound to the hydroxyl group of polyalkylene glycol include polyoxyethylene acetate, polyoxyethylene propionate, polyoxyethylene butyrate, polyoxyethylene valerate, polyoxyethylene caproate, polyoxyethylene heptanoate, polyoxyethylene octanoate, polyoxyethylene nonanate, polyoxyethylene caprate, polyoxyethylene laurate, polyoxyethylene myristate, polyoxyethylene palmitate, polyoxyethylene stearate, polyoxyethylene oleate, polyoxyethylene linoleate, polyoxypropylene acetate, polyoxypropylene propionate, polyoxypropylene butyrate, polyoxypropylene valerate, polyoxypropylene caproate, polyoxypropylene heptanoate, polyoxypropylene octanoate, polyoxypropylene nonanate, polyoxypropylene caprate, polyoxypropylene laurate, polyoxypropylene myristate, polyoxypropylene palmitate, polyoxypropylene stearate, polyoxypropylene oleate and polyoxypropylene linoleate. However, these are not limitative, and may be used either alone or in combination thereof.

Furthermore, to sufficiently exhibit the effect of these polyvalent alcohols, it is preferable to form a cellulose acylate film from a molten material under the conditions mentioned below. More specifically, the cellulose acylate film is formed by mixing cellulose acylate and a polyhydric alcohol to form pellets, melting the pellets in an extruder and extruding from a T die. Preferably, the outlet temperature (T2) of the extruder is higher than the inlet temperature (T1). Further preferably the temperature (T3) of the die is higher than the outlet temperature (T2) of the extruder. In short, it is preferable that as melting of the pellets proceeds, the temperature of the product line increases. This is because, if the temperature of a raw material fed from the inlet is raised sharply, the polyhydric alcohol is first liquefied to become a liquid, with the result that cellulose acylate floats in the liquefied polyhydric alcohol. To the raw material in such a state, shearing force from a screw cannot be sufficiently applied. As a result, a non-molten product is produced. When the raw material not well mixed as mentioned, the effect of a plasticizer as mentioned above cannot be produced and the effect of suppressing the difference between the upper surface and the lower surface of a melt-film after extrusion of the molten film cannot be obtained. Furthermore, a non-molten product turns into a foreign matter like a fish eye after film formation. Such a foreign matter does not look bright under observation using a polarizer and is visually observed on a screen by projecting light from the back surface of the resultant film. The fish eye causes tailing at the outlet of the die and increasing the number of die lines.

T1 is preferably 150° C. to 200° C., more preferably 160° C. to 195° C., and further preferably 165° C. to 190° C. T2 is preferably 190° C. to 240° C., more preferably 200° C. to 230° C., and further preferably 200° C. to 225° C. It is important that inlet and outlet temperatures T1, T2 of an extruder are 240° C. or less. If the temperatures T1, T2 exceed 240° C., the elastic modulus of the resultant film is apt to increase. This is considered because melting takes place at high temperature, cellulose acylate is decomposed, which causes crosslinking and increases elastic modulus. The die temperature T3 is preferably 200° C. to less than 235° C., more preferably 205° C. to 230° C. and further preferably 205° C. to 225° C. (both inclusive).

(2) Stabilizer

In the present invention, as a stabilizer, either one or both of a phosphite based compound and a phosphite ester based compound are preferably used. By the presence of the stabilizer, deterioration with time can be suppressed and die lines can be improved. This is because these compounds stabilizer acts as a leveling agent to cancel die lines formed by the concave-convex portions of the die. The content of the stabilizer is preferably 0.005% by mass to 0.5% by mass, more preferably 0.01% by mass to 0.4% by mass, and further preferably 0.02% by mass to 0.3% by mass.

(i) Phosphite Based Stabilizer

A phosphite based coloring inhibitor is not particularly limited; however, phosphite based coloring inhibitors represented by chemical formulas (general formula) (1) to (3) are preferable.

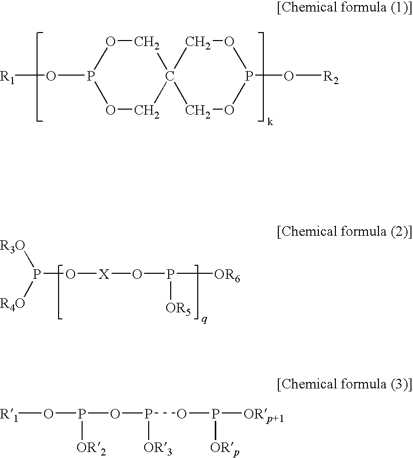

where R1, R2, R3, R4, R5, R6, R′1, R′2, R′3 . . . R′n, R′n+1 each is a group selected from the group consisting of a hydrogen atom, alkyl, aryl, alkoxyalkyl, aryloxyalkyl, alkoxyaryl, arylalkyl, alkylaryl, polyaryloxyalkyl, polyalkoxyalkyl and polyalkoxyaryl groups having 4 to 23 carbon atoms. However, in each of the chemical formulas (1), (2), (3), all of the R1, R2, R3, R4, R5, R6, R′1, R′2, R′3 . . . R′n, R′n+1 are not hydrogen atoms and all of the functional groups RX are not hydrogen atoms and any one of the functional groups is a functional group (e.g., alkyl group) as mentioned above.

In the phosphite based coloring inhibitor represented by the general formula (2), X represents a group selected from the group consisting of an aliphatic chain, an aliphatic chain having an aromatic nucleus as a side chain, an aliphatic chain having an aromatic nucleus in the chain, and a chain having oxygen atoms (two or more oxygen atoms are not present next to each other). Furthermore, k and q each are an integer of 1 or more and p is an integer of 3 or more.

The integer k and q of the phosphite based coloring inhibitor are preferably an integer of 1 to 10. This is because when the integer k and q each are 1 or more, the volatility during heating decreases, whereas when the integer k and q each are 10 or less, the compatibility of the phosphite based coloring inhibitor with cellulose acetate propionate is improved. Furthermore, the value of p is preferably 3 to 10. This is because, when p is 3 or more, the volatility during heating decreases, whereas when p is 10 or less, the compatibility of the phosphite based coloring inhibitor with cellulose acetate propionate is improved.

As a phosphite based coloring inhibitor represented by the general formula (4) below, for example, compounds represented by the following formulas (5) to (87) are preferable.

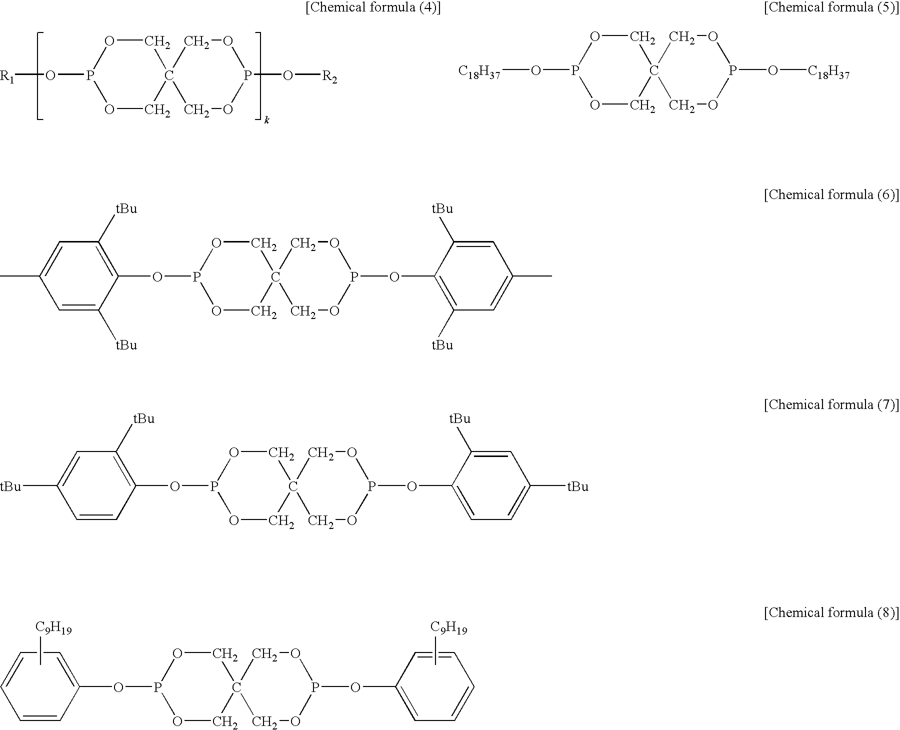

As a phosphite based coloring inhibitor represented by the chemical formula (general formula) (9) below, for example, compounds represented by the following chemical formulas (10) to (12) are preferable.

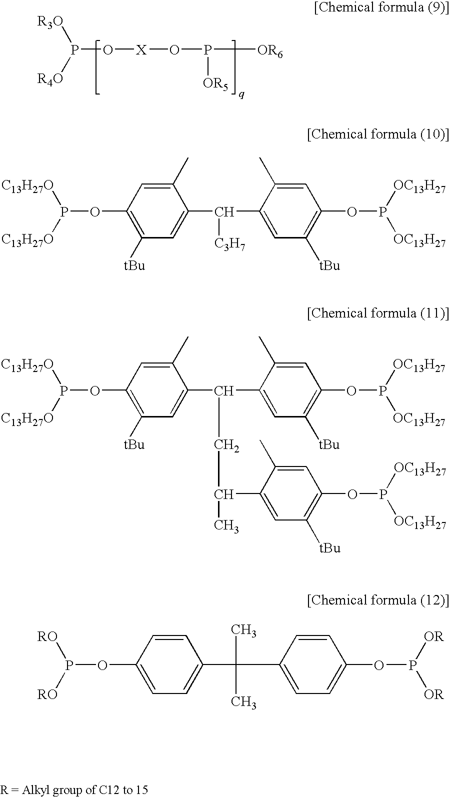

(ii) Phosphite stabilizer

Examples of the phosphite stabilizer include cyclic neopentanetetraylbis(octadecyl)phosphite, cyclic neopentanetetraylbis(2,4-di-t-butylphenyl)phosphite, cyclic neopentanetetraylbis(2,6-di-t-butyl-4-methylphenyl)phosphite, 2,2-methylenebis(4,6-di-t-butylphenyl)octylphosphite, and tris(2,4-di-butylphenyl)phosphite.

(iii) Other Stabilizer

A weak organic acids, thioether compound, or epoxy compound may be blended as a stabilizer. The weak organic acid is not particularly limited as long as it has a pKa value of 1 or more, does not prevent the function of the present invention, and prevents coloring and deterioration of physical properties. Examples of such a stabilizer include tartaric acid, citric acid, malic acid, fumaric acid, oxalic acid, succinic acid, and maleic acid. They may be used singly or in a mixture of two or more types.

Examples of the thioether compound include dilaurylthiodipropionate, ditridecylthiodipropionate, dimrystylthiodipropionate, distearylthiodipropionate and palmitylstearylthiodipropionate. They may be used singly or in a mixture of two or more types.

Examples of the epoxy compound include a compound derived from epichlorohydrin and bisphenol A, a derivative of epichlorohydrin and glycerin and a cyclic compound such as vinylcyclohexene dioxide and 3,4-epoxy-6-methylcyclohexylmethyl-3,4 epoxy-6-methylcyclohexane carboxylate. Furthermore, epoxylated soybean oil, epoxylated castor oil, and long-chain α-olefin oxides may be used. They may be used singly or in a mixture of two or more types.

(3) Cellulose Acylate

(Cellulose Acylate Resin)

(Composition/Substitution Degree)

The cellulose acylate (resin) used in the present invention preferably satisfies all requirements represented by Equations (1) to (3).

2.0≦A+B≦3.0 Equation (1)

0≦A≦2.0 Equation (2)

1.0≦B≦2.9 Equation (3)

In the Equations (1) to (3), A represents a substitution degree of acetate groups, B is the sum of substitution degrees of a propionate group, a butyrate group, a pentanoyl group, and a hexanoyl group.

Preferably,

2.0≦A+B≦3.0 Equation (4)

0≦A≦1.8 Equation (5)

1.2≦B≦2.9 Equation (6)

More preferably

2.4≦A+B≦3.0 Equation (7)

0.05≦A≦1.7 Equation (8)

1.3≦B≦2.9 Equation (9)

Further preferably

2.5≦A+B≦2.95 Equation (10)

0.1≦A≦1.55 Equation (11)

1.4≦B≦2.85 Equation (12)

As described above, cellulose acylate is produced by introducing a propionate group, a butyrate group, a pentanoyl group, and a hexanoyl group into cellulose. When the above range is obtained, a melting temperature is decreased and thermolysis associated with film formation from a molten material can be suppressed and it is preferable. On the other hand, the melting temperature and the thermolysis temperature are closed to each other, and it is difficult to suppress thermolysis outside range and it is not preferable.

These cellulose acylate compounds may be used singly or in a mixture of two or more types. Polymer components except for cellulose acylate may be appropriately mixed. Next, a method for manufacturing the cellulose acylate to be used in the present invention will be explained in detail. A raw material, cotton and a synthetic method for cellulose acylate of the present invention are more specifically described in Technical Report No. 2001-1745, published on Mar. 15, 2001 by the Japan Institution of Invention and Innovation, pages 7 to 12).

(Raw Material and Pretreatment)

A cellulose material is preferably derived from a broad-leaved tree, a coniferous tree, and cotton linter. As a cellulose material, a high-purity material containing a-cellulose in a high amount of 92% by mass to 99.9% by mass (both inclusive) is preferable. When a cellulose material is in the form of film and mass, it is preferable to break it in advance. Cellulose is preferably broken to a fluff state.

(Activation)

Prior to acylation, it is preferable that a cellulose material is brought into contact with the activating agent (activating treatment). As the activating agent, a carboxylic acid or water may be used. The cellulose material may be added to the activating agent by a method selected from spraying, dropwise adding and soaking.

Preferable examples of a carboxylic acid serving as an activating agent include a carboxylic acid having 2 to 7 carbon atoms such as acetic acid, propionic acid, butyric acid, 2-methylpropionic acid, valeric acid, 3-methylbutyric acid, 2-methylbutyric acid, 2,2-dimethylpropionic acid (pivalic acid), hexanoic acid, 2-methylvaleric acid, 3-methylvaleric acid, 4-methylvaleric acid, 2,2-dimethylbutyric acid, 2,3-dimethylbutyric acid, 3,3-dimethylbutyric acid, cyclopentane carboxylic acid, heptanoic acid, cyclohexane carboxylic acid, and benzoic acid; more preferable examples are acetic acid, propionic acid and butyric acid. Of them, acetic acid is particularly preferable.

In activating, if necessary, an acylation catalyst such as sulfuric acid may be further added in an amount of preferably of about 0.1% by mass to 10% by mass relative to cellulose. Furthermore, two or more types of activating agents may be added or an anhydride of a carboxylic acid having 2 to 7 carbon atoms may be added.

In activating, it is preferable that the amount of an acylation catalyst such as sulfuric acid further added is 0.1% by mass up to 10% by mass relative to cellulose. Furthermore, two or more types of activating agents may be added or an anhydride of a carboxylic acid having 2 to 7 carbon atoms may be added.

The addition amount of the activating agent is preferably not less than 5% by mass relative to cellulose, more preferably not less than 10% by mass, and particularly preferably, not less than 30% by mass. The uppermost limit of the addition amount of the activating agent is not particularly limited as long as a productivity is not reduced; however, the addition amount is preferably 100 fold or less relative to the mass of cellulose, more preferably 20 fold or less, and particularly preferably, 10 fold or less.

The time for an activation treatment is preferably 20 minutes or more. The uppermost limit of the activation time is not particularly limited as long as it does not effect upon the productivity; however, preferably 72 hours or less, more preferably 24 hours or less, and particularly preferably 12 hours or less. The temperature for activation is 0° C. to 90° C. (both inclusive), further preferably 15° C. to 80° C. (both inclusive), and particularly preferably 20° C. to 60° C. (both inclusive).

(Acylation)

The cellulose acylate to be used in the present invention may be prepared by a method of adding or sequentially supplying two types of carboxylic acid anhydrides to cellulose to react them;

a method of using an hydride of a mixture of two types of carboxylic acids (e.g., acetic acid/propionic acid anhydride mixture) to react with cellulose;

a method of synthesizing an acid anhydride mixture (e.g., acetic acid/propionic acid anhydride mixture) in the reaction system from a carboxylic acid and an acid anhydride of another carboxylic acid (acetic acid and anhydride of propionic acid) as starting materials and then reacting the mixture with cellulose; and a method of once synthesizing cellulose acylate having a substitution degree of less than 3 and then acylating remaining hydroxy groups with an acid anhydride and an acid halide. As to synthesis of cellulose acylate having a high degree of substation at the 6th position, these are descriptions in Japanese Patent Application Laid-Open Nos. 11-5851, 2002-212338, and 2002-338601 or the like.

(Acid Anhydride)

As an anhydride of a carboxylic acid, mention preferably is made of a hydride of a carboxylic acid having 2 to 7 carbon atoms such as an acetic anhydride, propionic anhydride, butyric anhydride, hexanoic anhydride, and benzoic anhydride. More preferably acetic anhydride, propionic anhydride, butyric anhydride, and hexanoic anhydride; and particularly preferably, acetic anhydride, propionic anhydride, and butyric anhydride may be mentioned.

Acetic anhydride is generally added to cellulose in an excessive amount. More specifically, acetic anhydride is added in an amount of 1.1 to 50 equivalents relative to a hydroxy group of cellulose, more preferably 1.2 to 30 equivalents, and particularly preferably, 1.5 to 10 equivalents.

(Catalyst)

As a catalyst for acylation used in production of cellulose acylate according to the present invention, Bronsted acid or Lewis acid is preferably used. The definitions of Bronsted acid or Lewis acid are found in a physicochemistry dictionary “Rikagaku Jiten”, the 5th edition, (2000). More preferably sulfuric acid or perchloric acid is used as the catalyst, and sulfuric acid is particularly preferable. The preferable amount of a catalyst is 0.1% by mass to 30% by mass relative to cellulose, more preferably 1% by mass to 15% by mass, and particularly preferably, 3% by mass to 12% by mass.

(Solvent)

In an acylation reaction, a solvent may be added in order to adjust viscosity, reaction rate, stirring property and acyl group substitution rate. As a solvent, carboxylic acid is preferably mentioned, more preferably a carboxylic acid having 2 to 7 carbon atoms such as acetic acid, propionic acid, butyric acid, hexanoic acid, and benzoic acid, and particularly preferably, acetic acid, propionic acid and butyric acid may be mentioned. These solvents may be used in the form of admixture.

(Acylation Conditions)

In an acylation reaction, an acid anhydride and a catalyst, and if necessary, a solvent are mixed, and thereafter mixed with cellulose. Alternatively, they may be sequentially added, thereby individually and separately mixing with cellulose. Generally, it is preferable that a mixture of an acid anhydride and a catalyst or a mixture of an acid anhydride, catalyst and solvent is prepared as an acylating agent, and then, the acylating agent is reacted with cellulose. The acylating agent is preferably cooled in advance to suppress an increase of temperature within a reaction container due to heat generation during acylation reaction.

An acylating agent may be added to cellulose at a time or in separate portions. Alternatively, cellulose may be added to an acylating agent at a time or in separate portions. The highest temperature that the acylation reaction reaches is preferably 50° C. or less. This is because when the reaction temperature is 50° C. or less, depolymerization does not proceed, with the result that cellulose acylate having an unappropriate polymerization degree is rarely obtained. The uppermost temperature that the acylation reaction reaches is preferably 45° C. or less, more preferably 40° C. or less, and particularly preferably, 35° C. or less. The lowermost temperature of the reaction is preferably −50° C. or more, more preferably −30° C. or more, and particularly preferably, −20° C. or more. The acylation time is preferably 0.5 hours and 24 hours (both inclusive), more preferably 1 to 12 hours (both inclusive) and particularly preferably, 1.5 to 10 hours (both inclusive).

(Reaction Terminator)

In a method for manufacturing cellulose acylate to be used in the present invention, a reaction terminator may preferably be added following the acylation reaction. Any reaction terminator may be added as long as it decomposes an acid anhydride. Preferable examples of such a reaction terminator include water, alcohol such as ethanol, methanol, propanol, isopropyl alcohol, and a composition containing these. Preferably, a mixture of a carboxylic acid such as acetic acid, propionic acid or butyric acid and water is added. As a carboxylic acid, acetic acid is particularly preferable. A carboxylic acid and water may be used in any ratio; however, the content of water is preferably within the range of 5% by mass to 80% by mass, further preferably 10% by mass and 60% by mass, and particularly preferably, 15% by mass to 50% by mass.

(Neutralization Agent)

In or after the acylation reaction termination reaction, to hydrolyze anhydrous carboxylic acid excessively present in the reaction system, neutralize a part or whole carboxylic acid and an esterification catalyst, and control of the amounts of remaining sulfate group and remaining metal, a neutralization agent or its solution may be added.

As preferable examples of the neutralization agent include ammonium, organic quaternary ammonium, alkaline metals, carbonates, hydrogen carbonates, organic acid salts (such as an acetate, propionate, butyrate, benzoate, phthalate, hydrogen phthalate, citrate, and tartrate) hydroxides and oxides of the II-group metal, III-XII group metal and XIII-XV-group element. Further preferable examples of the neutralization agent include carbonates, hydrogen carbonates, organic acid salt, hydroxide and oxides of an alkaline metal or the II-group metal. Particularly preferable examples thereof include carbonates, hydrogen carbonate, acetate and hydroxides of sodium, potassium, magnesium and calcium. Preferable examples of a solvent for the neutralization agent include water, an organic acid such as acetic acid, propionic acid, and butyric acid, and mixtures of these solvents.

(Partial Hydrolysis)

The cellulose acylate thus obtained has an entire substitution rate close to 3. To obtain cellulose acylate having a desired degree of substation, the cellulose acylate is generally maintained in the presence of a small amount of a catalyst (generally, an acylating catalyst such as remaining sulfuric acid) and water at 20° C. to 90° C. for several minutes to several days to partially hydrolyze an ester bond, thereby reducing the substitution degree of cellulose acylate with an acylate group to a desired level. This is called as “maturation.” At the time point where a desired cellulose acylate is obtained, preferably, the remaining catalyst present in the reaction system is completely neutralized with a neutralization agent as mentioned above or its solution to terminate the partial hydrolysis. Alternatively, a neutralization agent such as magnesium carbonate, magnesium acetate, generating a salt having a low solubility in the reaction solution is preferably added to the reaction solution to effectively remove the catalyst (such as sulfuric ester) in the solution or bound to cellulose.

(Filtration)

The reaction mixture is preferably filtrated to remove or reduce an unreacted product in cellulose acylate, less-soluble salt and other foreign matters. Filtration is performed in any step from completion of acylation to reprecipitation. Prior to filtration, the reaction mixture is preferably diluted with an appropriate solvent to control filtration pressure and handling. A cellulose acylate solution is obtained though filtration.

(Reprecipitation)

The cellulose acylate solution thus obtained is mixed with water or a poor solvent such as an aqueous solution of a carboxylic acid, acetic acid or propionic acid, or a poor solvent is mixed with the cellulose acylate solution to reprecipitate cellulose acylate. The reprecipitated cellulose is washed and applied by stabilization treatment to obtain desired cellulose acylate. The reprecipitation operation of the cellulose acylate solution is continuously performed or in a batch several times (predetermined amount per time).

(Washing)

The cellulose acylate thus produced is preferably washed. Any washing solvent may be used as long as it less dissolves cellulose acylate and can remove impurities; however, generally water or warm water is used. Proceeding of washing may be monitored by any means; however, preferably monitored by hydrogen ion concentration analysis, ion chromatography, electric conductivity analysis, ICP (high frequency induction coupling plasma) emission spectroscopic analysis, element analysis, or atomic adsorption analysis.

(Stabilization)

Cellulose acylate after washed with warm water is preferably treated also with an aqueous solution of weak alkali such as carbonate, hydrogen carbonate, hydroxide or oxide of sodium, potassium, calcium, magnesium, or aluminium in order to further improve stability or reduce the odor of carboxylic acid.

(Drying Step)

In the present invention, to control the water content of cellulose acylate to a preferable amount, it is preferred to dry cellulose acylate. A drying step is preferably performed at a temperature of 0° C. to 200° C., further preferably 40° C. to 180° C., and particularly preferably 50° C. to 160° C. The cellulose acylate of the present invention preferably has a water content of not more than 2% by mass or less, further preferably not more than 1% by mass, and particularly preferably, not more than 0.7% by mass.

(Configuration)

The cellulose acylate of the present invention may take various shapes such as granular, powdery, fibrous, and massive forms. Granular or powdery shape is preferable as a raw material for producing a film. Therefore, cellulose acylate after dry may be pulverized or sieved to improve homogeneity of particles and handling thereof. When cellulose acylate takes a particle shape, not less than 90% by mass of the particles preferably has a particle size of 0.5 mm to 5 mm. Furthermore, not less than 50% by mass of the particles to be used preferably has a particle size of 1 mm to 4 mm. It is preferred that the shape of cellulose acylate particles is as circular as possible. The cellulose acylate particles to be used in the present invention preferably has an apparent density of 0.5 g/cm³ to 1.3 g/cm³, further preferably 0.7 g/cm³ to 1.2 g/cm³, and particularly preferably, 0.8 g/cm³ to 1.15 g/cm³. A method of measuring an apparent density is defined in the JIS (Japanese Industrial Standard) K-7365. The cellulose acylate particles of the present invention preferably have a repose angle of 10° to 70°, further preferably 15° to 60°, and particularly preferably, 200 to 500.

(Polymerization Degree)

The polymerization degree of cellulose acylate preferably used in the present invention is 100 to 700, preferably 120 to 600, and further preferably 130 to 450 in average. The average polymerization degree is measured, for example, by a limiting viscosity method proposed by Uda et al. (Kazuo Uda, Hideo Saito, the official journal of the Society of Fiber Science and Technology, Japan, Vol. 18, No. 1, page 105 to 120, 1962) and gel permeation chromatography (GPC). These methods are more specifically described in Japanese Patent Application Laid-Open No. 9-95538.

### [Synthesis Examples of Cellulose Acylate]

Synthesis examples of cellulose acylate used in the present invention will be described below; however, the present invention will not be limited to these.

An acylating agent was selected from acetic acid, acetic anhydride, propionic acid, propionic anhydride, butyric acid, and butyric anhydride, singly or in combination, depending upon a desired substitution degree with an acyl group. Then, cellulose, the acylating agent and sulfuric acid serving as a catalyst were mixed. The mixture was subjected to an acylation reaction performed while maintaining a reaction temperature of 40° C. or less. After cellulose as raw material was consumed (completion of acylation), the reaction solution was further heated at 40° C. or less to control degree of polymerization of cellulose acylate to a desired level. An aqueous acetic acid solution was added to hydrolyze the remaining acid anhydride and then the reaction solution was heated to 60° C. or less to perform partial hydrolysis of cellulose acylate to control the whole substitution degree thereof to a desired level. The remaining sulfuric acid was neutralized by adding excessive magnesium acetate. Reprecipitation was performed from an aqueous acetic acid solution and washing repeatedly with water to obtain cellulose acylate.

The composition of an acylating agent, the temperature and time for the acylation reaction, the temperature and time of partial hydrolysis are varied depending upon a desired substitution degree and polymerization degree, to synthesize cellulose acylate different in substitution degree and polymerization degree.

(4) Other Additives

(i) Matting Agent

It is preferred to add fine particles as a matting agent. As the fine particles to be used in the present invention, mention may be made of silicon dioxide, titanium dioxide, aluminium oxide, zirconium oxide, calcium carbonate, talc, clay, calcined kaolin, calcined calcium silicate, hydrated calcium silicate, aluminum silicate, magnesium silicate and calcium phosphate. The fine particles contain silicon is preferable in view of lowering turbidity. In particular, silicon dioxide is preferably used. It is preferred that the fine particles of silicon dioxide have an average primary particle size of 20 nm or less and an apparent specific gravity of 70 g/L or more. The average primary particle size is more preferably as small as 5 nm to 16 nm because haze can be reduced. The apparent specific gravity is preferably 90 g/L to 200 g/L and more preferably 100 g/L to 200 g/L. The apparent specific gravity is larger, the more preferable. This is because a high-concentration dispersion solution can be prepared to improve haze and aggregation.

These fine particles usually form secondary particles having an average particle size of 0.1 μm to 3.0 μm. These secondary particles are present in the form of aggregates of primary particles on a film surface to contribute to producing convex-concave portions of 0.1 μm to 3.0 μm. The average secondary particle size is preferably 0.2 μm to 1.5 μm (both inclusive), further preferably 0.4 μm to 1.2 μm (both inclusive), and most preferably, 0.6 μm to 1.1 μm (both inclusive). The particle size of the primary and secondary particles is represented by the diameter of the circumscribed circle of a particle and measured under observation of a scanning electron microscope. The diameters of 200 particles were measured by changing the viewing field of the microscope to obtain an average particle size thereof.

As the fine particles of silicon dioxide, use may be made of commercially available products such as aerosil R972, R972V, R974, R812, 200, 200V, 300, R202, OX50, TT600 (these are all manufactured by Japan Aerosil Industry Co., Ltd.). As the fine particles of zirconium oxide, use may be made of commercially available products R976 and R811 (these are all manufactured by Japan Aerosil Industry Co., Ltd.). Of them, aerosil 200V, aerosil R972V, which are fine particles of silicon dioxide having an average primary particle size of 20 nm or less and an apparent specific gravity of 70 g/L or more, are particularly preferable since they are effective in reducing abrasion coefficient while maintaining low turbidity of the resultant optical film.

(ii) Other Additives

Besides aforementioned additives, various additives such as a UV protective agent (e.g., a hydroxybenzophenone compound, benzotriazole compound, salicylic acid ester compound, and cyanoacrylate compounds), infrared absorber, optical regulator, surfactant, and odor-trapping agent (amine, etc.) may be added. Details of them are described in Technical Report No. 2001-1745, published on Mar. 15, 2001 by the Japan Institution of Invention and Innovation, pages 17 to 22) and materials described in this report may be preferably used.

As the infrared absorber, those described in Japanese Patent Application Laid-Open No. 2001-194522 may be used. As the UV protective agent, those described in Japanese Patent Application Laid-Open No. 2001-151901 may be used. They each are preferably contained in an amount of 0.001% by mass to 5% by mass relative to cellulose acylate.

As the optical regulator, a retardation regulator may be mentioned. As the retardation regulator, use may be made of those described in Japanese Patent Application Laid-Open Nos. 2001-166144, 2003-344655, 2003-248117, and 2003-66230. The in-plane retardation (Re) and thickness-direction retardation (Rth) can be controlled by the retardation regulator. The addition amount of the retardation regulator is preferably not more than 10% by mass, more preferably not more than 8% by mass, and further preferably not more than 6% by mass.

(5) Physical Properties of Cellulose Acylate Mixture

The cellulose acylate mixture (containing cellulose acylate, plasticizer, stabilizer and other additives) preferably satisfies the following physical properties.

(i) Ratio of Heating Loss

The ratio of heating loss refers to the ratio of weight loss of a sample at a temperature of 220° C. when the sample is heated from room temperature at a temperature-increasing rate of 10° C./minute under nitrogen gas atmosphere. When the composition of the cellulose acylate mixture is prepared as mentioned above, the ratio of heating loss can be preferably controlled within the range of not more than 5% by weight, more preferably not more than 3% by weight, and further preferably not more than 1% by weight. By virtue of this, damage such as bubbles produced during a film formation unit can be suppressed.

(ii) Melt Viscosity

The cellulose acylate mixture preferably has a melt viscosity per sec at 220° C. of 100 Pa·s to 1000 Pa·s, more preferably 200 Pa·s to 800 Pa·s, and further preferably 300 Pass to 700 Pa·s. When the melt viscosity of the cellulose acylate mixture is set as high as mentioned above, the tensile extension (drawing) of a melt occurring at the outlet of a die can be prevented, successfully preventing an increase of optical anisotropy (retardation) due to orientational ordering caused by the drawing. The viscosity can be controlled by any method; however controlled by varying the polymerization degree of cellulose acylate and the amount of additional agents such as a plasticizer.

(6) Pelletization

The cellulose acylate mixture is preferably pelletized before melted to form a formation. The cellulose acylate mixture is preferably dried in advance of pelletizing. However, the drying operation and extrusion operation both can be simultaneously carried out by a bent-style extruder. When a drying step is separately performed, the mixture is dried in a heating furnace at 90° C. for 8 hours or more. However, the drying step may be limited to this method. Pelletization is performed as follows. The cellulose acylate mixture is melted in a double screw kneading extruder at 150° C. to 250° C. (both inclusive) and thereafter extruded in noodle form. After the noodle is solidified in water and cut. Alternatively, pelletization may be performed by an under-water cut method, in which the noodle is cut in water upon extruding the melt from a nozzle.

As long as melting and kneading is sufficiently performed, any known extruder may be used such as a single screw extruder, non-intermeshing and counter-rotating double screw extruder, intermeshing and counter-rotating double screw extruder and intermeshing and co-rotating double screw extruder.

The size of pellets may preferably fall within the range of 1 mm² to 300 mm² (both inclusive) in sectional area and 1 mm to 30 mm (both inclusive) in length, and more preferably 2 mm² to 100 mm² (both inclusive) in section area and 1.5 mm to 10 mm (both inclusive) in length. In pelletizing, the additives mentioned above may be posted from a raw material inlet and a ventilation port provided in the middle of the extruder.

The rotation number of the extruder is preferably 10 rpm to 1000 rpm (both inclusive), more preferably 200 rpm to 700 rpm (both inclusive), and further preferably 30 rpm to 500 rpm (both inclusive). When a lower rotation number than the range is not preferable because the retention time of the mixture in the extruder becomes long, causing heat deterioration, with the result that molecular weight decreases and yellowish color degrades. On the other hand, when an excessive higher rotation number is not preferable because cleaving of the molecule by shearing is likely to cause, with the results that molecular weight reduces and crosslinking gel increases.

The retention time of the melt in the extruder in pelletizing is preferably 10 seconds to 30 minutes (both inclusive), more preferably 15 seconds to 10 minutes (both inclusive), and further preferably 30 seconds to 3 minutes (both inclusive). The shorter the retention time, the better as long as the mixture sufficiently melts. This is because resin deterioration and color change to yellow can be suppressed.

(7) Melt Film Formation

(i) Dry Step

Pellets mentioned above are preferably formed. The water content of the pellets is preferably reduced before melt film formation. To control the water content of cellulose acylate in the present invention, it is preferably to dry the cellulose acylate. A dehumidification air drier is frequently used in drying cellulose acylate, but not particularly limited thereto as long as a desired water content is obtained. It is preferred that cellulose acylate is efficiently dried by a device such as heating, blasting, pressure reduction, and stirring, singly or in combination. Further preferably a heat-insulated dry hopper is constructed. The drying temperature is preferably 0° C. to 200° C., further preferably 40° C. to 180° C., and particularly preferably 60° C. to 150° C. It is not preferable that the drying temperature is too low, because not only long time is required for dry but also a desired water content is not obtained. It is also not preferable that the drying temperature is too high, because the resin becomes sticky, causing blocking. The dry-air amount is preferably 20 m³/hour to 400 m³/hour, further preferably 50 m³/hour to 300 m³/hour, and particularly preferably 100 m³/hour to 250 m³/hour. It is not preferable that the amount of dry air is low, because the drying rate is low. On the other hand, even if the amount of dry air is increased, further drastic improvement in drying rate is not expected when the dry-air amount exceeds over a certain level. Therefore, increasing the amount of dry air is unfavorable in an economic point of view. The dew point of air is preferably 0° C. to −60° C., further preferably −10° C. to −50° C., and particularly preferably −20° C. to −40° C. As the drying time, at least 15 minutes is preferably required, and further preferably 1 hour or more, and particularly preferably, 2 hours or more. On the other hand, when pellets are dried beyond 50 hours, the effect of reducing water content is not expected and thermal deterioration of a resin may occur. For the reason, it is not preferable that the drying step is performed for unnecessarily long time. According to the cellulose acylate of the present invention, the water content is preferably not more than 1.0% by mass, further preferably not more than 0.1% by mass, and particularly preferably, 0.01% by mass.

(ii) Melt-Extruding

The cellulose acylate is supplied through a supply port of an extruder (different from the extruder used in pelletization mentioned above) into the cylinder. The cellulose acylate (resin) is preferably dried to reduce the water content thereof by a method as mentioned above. To prevent oxidization of a molten resin with the residual oxygen, it is preferable that the drying step is performed in an inert gas such as nitrogen or in vacuum while exhausting an extruder with ventilation. The screw compression ratio of the extruder is set at 2.5 to 4.5 and the L/D ratio is set at 20 to 70. The L/D ratio refers to the ratio of the length to the inner diameter of the cylinder. Furthermore, the extrusion temperature is set at 190 to 240° C. When the inner temperature of the extruder exceeds 240° C., it is better to provide a cooler between the extruder and the die.

When the L/D is too small as low as less than 20, the mixture is not sufficiently melted or kneaded, with the result that fine crystals tend to leave in the resultant cellulose acylate film. Conversely, when the L/D is too large as high as more than 70, the retention time of cellulose acylate resin in the extruder becomes too long, with the result that deterioration of the resin is likely to cause. Furthermore, when the retention time becomes long, molecules tend to break, with the result that the molecular weight reduces, weakening mechanical strength of the resultant cellulose acylate film. Accordingly, to suppress the resultant cellulose acylate film from turning yellow and form a strong film sufficient to prevent breakage of the film by drawing, the L/D ratio preferably falls within the range of 20 to 70, more preferably 22 to 65, and particularly preferably, 24 to 50.

The extrusion temperature is preferably set at the aforementioned temperature range. The cellulose acylate film thus obtained has characteristic values—a haze of 2.0% or less and a yellow index (Y1 value) of 10 or less.

The haze used herein is an index to know whether the extrusion temperature is too low, in other words, an index to know the level of crystal amount remaining in the resultant cellulose acylate film. When a haze value exceeds 2.0%, the mechanical strength of the resultant cellulose acylate film decreases and breakage of the film tend to take place by drawing. On the other hand, the yellow index (Y1 value) serves as an index to know whether the extrusion temperature is too high. When a yellow index (Y1 value) is 10 or less, no problem is produced with respect to yellow coloring.

As the extruder, a single screw extruder relatively cheep in equipment cost is generally used, which include Full flight, Madoc and Dulmage types. When cellulose acylate relatively low in thermal stability is used, the Full flight type is preferable. On the other hand, a double screw extruder may be used although its equipment cost is high but advantageous because extrusion can be performed while vaporizing unnecessary volatile components from a ventilation port, which is provided in the middle of the extruder by changing a screw segment. The double screw extruders are roughly divided into a co-rotating type and a counter rotating type. Both types may be used; however, the co-rotating type is preferable because retention of a resin rarely occurs and self-cleaning performance is high. The double screw extruder is expensive in equipment cost but excellent in kneading performance and in resin supply performance. Since a resin can be extruded at low temperature, the double screw extruder is suitable for forming a film using cellulose acylate. Cellulose acylate pellets and powder not yet dried can be used as they are by appropriately arranging a ventilation port. In addition, the edge cut out from a film during a film formation unit can be reused as it is without drying.

Note that a diameter of a screw varies depending upon the desired extrusion amount per unit time, preferably 10 mm to 300 mm (both inclusive), more preferably 20 mm to 250 mm (both inclusive) and further preferably 30 mm to 150 mm.

(iii) Filtration

To remove foreign matter from cellulose acylate and to prevent foreign matter from damaging gear pump, so-called breaker plate type filtration is preferably performed by providing a filter in the outlet of an extruder. Furthermore, to remove foreign matter efficiently, a filter device having a leaf-type disc filter installed therein is preferable provided downstream of a gear pump. A filtration filter may be provided a single site (single-stage filtration) or a plurality of sites (multiple-stage filtration). The higher the filtration accuracy of the filter, the better. However, in view of the withstand pressure of a filter and filtration pressure increased by filter clogging, the filtration accuracy is preferably 3 μm to 15 μm, and further preferably 3 μm to 10 μm. In particular, when a leaf-type disk filter is used in the final stage of filtration, a filter material having high filtration accuracy is preferably used from a quality point of view. The filtration accuracy can be controlled by varying the number of filters in view of appropriately maintaining withstand pressure and service life of a filter. Since the filter is used under high temperature/high pressure conditions, a filter formed of an iron steel material is preferably used. Of the iron steel materials, stainless steel and steel are particularly preferably used as the material. In consideration of corrosion, a stainless steel is desirably used. The filter may be a knitting of a line material and sintered filter formed by sintering long metal fiber or metal powder may be employed. In view of filtration accuracy and filter service life, the sintered filter is preferable.

(iv) Gear Pump

To improve the thickness accuracy of a film, it is important to reduce variance in ejection amount. To attain this, it is effective to provide a gear pump between the extruder and the die to supply cellulose acylate resin at a constant rate. The gear pump consists of a pair of gears: a driving gear and a driven gear, mutually engaged and housed in a pump. When the driving gear is driven, the driven gear engaged with the driving gear is rotated to suck molten resin into the cavity of the pump through a suction port formed in a housing (gear box) and then the molten resin is ejected from an ejection port formed in the housing at a constant rate. Even if the resin is extruded at a different pressure from the tip portion of the extruder, the difference is absorbed by use of a gear pump. As a result, the variance in pressure of the resin is reduced downstream of the film formation apparatus, thereby improving dimensional difference in the thickness direction.

Another method may also be employed to supply resin by the gear pump at a more constant rate. In this method, the pressure of the resin upstream of the gear pump is controlled constant by varying the rotation number of the screw. Alternatively, a method using an accurate gear pump using not less than three gears is effective since variance of gears can be overcome.

There are other merits when a gear pump is used. Since a film is formed while reducing the pressure of tip portion of the screw, it is expected to reduce energy consumption, prevent a temperature increase and improve the transportation efficiency of cellulose acylate, reduce retention time of resin in the extruder and the L/D ratio of the extruder. When a filter is used to remove foreign matter, the amount of resin supplied from a screw may vary as filtration pressure increases, if a gear pump is not used. However, this phenomenon can be overcome by use of the gear pump in combination.

The retention time of resin supplied through the supply port of the extruder and ejected from the die is preferably 2 minutes to 60 minutes (both inclusive), more preferably 3 minutes to 40 minutes (both inclusive), and further preferably 4 minutes to 30 minutes (both inclusive).

When a polymer circulating through bearing of the gear pump does not flow smoothly, the sealing performance by the polymer in a driving section and the bearing section degrades, causing problems such as variable measurement and large fluctuation of resin extrusion pressure. To overcome these problems, the gear pump must be designed (particularly paying attention to clearance) taking the melt viscosity of cellulose acylate into consideration. In some cases, the cellulose acylate remaining in the gear pump causes deterioration. Therefore, the structure of the gear pump must be designed such that resin retained as little as possible. Also, a pipe and adapter connecting the extruder and the gear pump or the gear pump and the die must be designed such that resin is retained as little as possible. In addition, to stabilize the extrusion pressure of cellulose acylate resin whose melt viscosity is highly dependent upon temperature, it is preferred that temperature fluctuation is reduced as much as possible. In general, to warm a pipe, a band heater (inexpensive in equipment cost) is frequently used, more preferably an aluminium cast heater (lower in temperature change) is used. Furthermore, to stabilize the ejection pressure of the extruder, 3 to 20 heaters are preferably provided around the barrel of the extruder to melt the resin.

(v) Die

Cellulose acylate is melted by the extruder having the aforementioned structure and the molten resin (cellulose acylate) is continuously fed to a die by way of, if necessary, a filter and a gear pump. Any type of die may be used as long as retention time of the molten resin in the die is short. Examples of the die include T die, fish-tale die and hanger-coat die. Furthermore, to increase temperature-uniformity of a resin, a static mixer may be provided upstream of the T-die. The clearance (lip clearance) of the outlet of the T-die is preferably 1.0 to 5.0 fold as large as film-thickness in general, more preferably 1.2 to 3 fold, and further preferably 1.3 to 2 fold. When the lip clearance is less than 1.0 fold as low as film-thickness, it is difficult to form a good planar film. In contrast, the lip clearance of more than 5.0 fold as large as film-thickness is not preferable, because the direction accuracy of a film decreases. The die is an extremely important unit for determining the thickness accuracy of the resultant film. Therefore, it is preferably to employ a die capable of severely controlling the thickness accuracy of the resultant film. Generally, the thickness of a film can be controlled by a die at a pitch of 40 mm to 50 mm. A die preferably controls the thickness of a film at a pitch of 35 mm or less, and further preferably 25 mm or less. Since cellulose acylate has a high dependency of melt viscosity on temperature and shearing rate, it is important to design a die having a small difference in temperature and flow rate in the width direction as must as possible. Furthermore, a die equipped with an automatic thickness regulator is known, which is placed downstream of the die and measures the film-thickness of the formed film, calculates the deviation of thickness and feedbacks calculation results to the thickness regulator, thereby controlling film-thickness. It is effective to employ such a die to reduce difference in film-thickness in a long-term continuous production.

A single layer forming apparatus cheep in equipment cost is generally used in forming a film. In some cases, a multiple layer forming apparatus may be used for forming a film formed of two layers different in type in the case of forming a functional layer as an outside layer. Generally, the functional layer is preferably formed as a thin layer on the surface; however, the thickness ratio of layers is not particularly limited.

(vi) Cast

A cellulose acylate extruded in the form of sheet from a die is solidified on a cooling drum to obtain a film. At this time, the adhesion between the cooling drum and the cellulose acylate extruded in the form of sheet is preferably improved by a method such as an electrostatic application method, air knife method, air chamber method, vacuum nozzle method or touch roll method. Such a method for improving adhesion may be applied to whole or part of the surface of the extruded sheet. In particular, a method called “edge pinning” is frequently employed for adhering only both edges of the sheet onto the cooling drum. However, the method of adhering the edges is not limited to this.

More preferably the sheet is gradually cooled by use of a plurality of cooling drums. Particularly three cooling drums are generally and frequently used but not limited to these. The diameter of the cooling drum is preferably 100 mm to 1000 mm (both inclusive), and more preferably 150 mm to 1000 mm (both inclusive). The intervals between cooling drums is preferably 1 mm to 50 mm (both inclusive), and more preferably 1 mm to 30 mm (both inclusive).

The temperature of the cooling drum is preferably 60° C. to 160° C. (both inclusive), more preferably 70° C. to 150° C. (both inclusive), and further preferably 80° C. to 140° C. (both inclusive). The cellulose acylate sheet is removed from the cooling drums and rolled up by way of nip rolls. The roll-up rate is preferably 10 m/minute to 100 m/minute (both inclusive), more preferably 15 m/minute to 80 m/minute (both inclusive), and further preferably 20 m/minute to 70 m/minute (both inclusive).

The width of a formed film is preferably 0.7 m to 5 m (both inclusive), more preferably 1 m to 4 m (both inclusive), and further preferably 1.3 m to 3 m (both inclusive). The thickness of the film (undrawn film) thus obtained is preferably 30 μm to 400 μm (both inclusive), more preferably 40 μm to 300 μm (both inclusive), and further preferably 50 μm to 200 μm (both inclusive).

When the touch roll method is employed, the surface of a touch roll may be formed of rubber, plastic such as Teflon (registered trade mark) or metal. Furthermore, a so-called flexible roll may be used. Since the flexible roll is made of a thin metal roll, the surface of the roll is depressed and the contact area is widen when a film is touched on the flexible roll. The temperature of the touch roll is preferably 60° C. to 160° C. (both inclusive), more preferably 70° C. to 150° C. (both inclusive), and further preferably 80° C. to 140° C. (both inclusive).

(vii) Roll Up

The sheet thus obtained is preferably trimmed at the both edges and rolled up. The trimmed edge portions may be crushed, if necessary, pelletized and depolymerized/repolymerizd, and recycled as a raw material for the same type or different type of film. As a trimming cutter, any type of cutter selected from a rotary cutter, sheer cutter, and knife, etc. may be used. Such a cutter may be formed of any type of material selected from carbon steel and stainless steel, etc. may be used. Generally, an ultra-hard knife and ceramic knife are preferably used because the cutter can be used for a long time without generating powdery cut chip.

Prior to rolled up, a laminate film is preferably attached at least one of both surfaces in view of preventing damage. A preferable tension in rolling up is 1 kg/m width to 50 Kg/width (both inclusive), more preferably 2 kg/m width to 40 kg/width (both inclusive), and further preferably 3 kg/m width to 20 Kg/width (both inclusive). The tension is less than 1 kg/m width, it is difficult to roll up the film uniformly. Conversely, it is not preferable to apply tension in excess of 50 kg/width. This is because the film is rolled up tightly. As a result, the appearance of the roll becomes bad. Besides, a bump portion of the film extends due to a creeping phenomenon and causes waving, or the extended film causes residual birefringence. Tensile during the roll-up step is preferably detected by a tension controller provided in the middle of the production line and controlled so as to apply a constant tension to the film to be rolled up. In a film formation line, if there is a place different in temperature, the film differs in length even slightly by thermal expansion. In this case, the ratio in drawing speed between nip rolls is controlled so as not to apply excessive tension over a predetermined value to the film in the middle of the production line.

Since the tension during a roll up step can be controlled by the tension controller, the film can be rolled up while applying a constant tension. Tension is preferably reduced with an increase of the diameter of a roll. In this manner, the film is preferably rolled up while applying an appropriate tension. In general, as the diameter of a roll increases, the tension is reduced little by little. However, it is sometimes preferred that the tension is increased as the roll diameter increases.

(viii) Physical Properties of Undrawn Cellulose Acylate Film

The undrawn cellulose acylate film thus obtained preferably has Retardation (Re) of 0 nm to 20 nm and retardation (Rth) of 0 nm to 80 nm, more preferably Re of 0 nm to 15 nm and Rth of 0 nm to 70 nm, and further preferably Re of 0 nm to 10 nm and Rth of 0 nm to 60 nm. Re and Rth represent in-plane retardation and retardation along the thickness, respectively. Re is measured by an analyzer, KOBRA 21ADH (Oji Scientific Instrument) with light incident upon the film in the normal-line direction. Rth is calculated based on retardation values measured in three directions. One is Re and others are retardation values measured by striking light at an incident angle of +400 and −40° relative to the normal line to the film (in this case, a delayed phase in the plane is used as a tilt axis (rotation axis)). Assuming that the angle formed between the film formation direction (length direction) and the delayed phase axis of Re of the film is represented by θ, θ is preferably closer to 0°, +90° or −90°. The transmittance of the all optical light is preferably 90% or more, more preferably 91% or more, and further preferably 98% or more. The haze is preferably 1% or less, more preferably 0.8% or less, and further preferably 0.6% or less.

The difference in thickness in the length direction and the width direction each preferably falls within the range of 0% to 4% (both inclusive), more preferably 0% to 3% (both inclusive), and further preferably 0% to 2% (both inclusive). The tensile elastic modulus is preferably 1.5 kN/mm² to 3.5 kN/mm² (both inclusive), more preferably 1.7 kN/mm² to 2.8 kN/mm² (both inclusive), and further preferably 1.8 kN/mm² to 2.6 kN/mm² (both inclusive). The break (ductility) is preferably 3% to 100% (both inclusive), more preferably 5% to 80% (both inclusive), and further preferably 8% to 50% (both inclusive).

Tg of the film (which refers to Tg of a mixture of cellulose acylate and additives) is preferably 95° C. to 145° C. (both inclusive), more preferably 100° C. to 140° C. (both inclusive), and further preferably 105° C. to 135° C. (both inclusive). The thermal dimensional changes of the film in the length and width direction at 80° C. per day, both are preferably 0% to ±1% (both inclusive), more preferably 0% to ±0.5% (both inclusive), and further preferably 0% to ±0.3% (both inclusive). The water permeability of the film at 40° C. at a relative humidity of 90% is preferably 300 g/m²/day to 1000 g/m²/day (both inclusive), more preferably 400 g/m²/day to 900 g/m²/day (both inclusive), and further preferably 500 g/m²/day to 800 g/m²/day (both inclusive). The equilibrium water content of the film at 25° C. at a relative humidity of 80% is preferably 1% by mass to 4% by mass (both inclusive), more preferably 1.2% by mass to 3% by mass (both inclusive), and further preferably 1.5% by mass to 2.5% by mass (both inclusive).

(8) Drawing

The film formed by a method as mentioned above may be drawn to control Re and Rth. The drawing may be performed preferably at Tg (° C.) to (Tg+50)° C. (both inclusive), more preferably (Tg+3)° C. to (Tg+30)° C. (both inclusive), and further preferably (Tg+5)° C. to (Tg+20)° C. (both inclusive). Drawing may be performed in at least one direction preferably at a rate of 1% to 300% (both inclusive), more preferably 2% to 250% (both inclusive), and further preferably 3% to 200% (both inclusive). Drawing is performed equally in the length and width directions; however preferably performed unequally. In other words, the drawing rate of one of the directions is preferably larger than the other. The drawing rate of either length direction or width direction may be larger; however, a smaller drawing rate is preferably 1% to 30% (both inclusive), more preferably 2% to 25% (both inclusive), and further preferably 3% to 20% (both inclusive). The larger drawing rate is preferably 30% to 300% (both inclusive), more preferably 35% to 200% (both inclusive), and further preferably 40% to 150% (both inclusive). Drawing may be performed in a single stage or multiple stages. The drawing rate is obtained in accordance with the following equation:

Drawing rate (%)=100×{(length after drawing)−(length before drawing}/(length before drawing)

Drawing may be performed by use of not less than two pairs of nip rolls in the longitudinal direction (longitudinal drawing) by setting the rotation speed (peripheral speed) of the roll at the side near the outlet larger. Alternatively, drawing may be performed in the perpendicular direction to the longitudinal direction (transverse drawing) while holding both edges of a film by a chuck. Furthermore, drawing can be performed simultaneously in both directions (biaxial drawing) as described in Japanese Patent Application Laid-Open No. 2000-37772, 2001-113591, and 2002-103445.

The ratio of Re and Rth can be freely controlled by controlling a length-width ratio obtained by dividing the length between nip rolls by a film width in the case of the longitudinal drawing. More specifically, a Rth/Re ratio is increased by reducing the length-width ratio. Alternatively, the ratio of Re and Rth can be controlled by the longitudinal drawing and transverse drawing in combination. More specifically, Re may be reduced by reducing the difference between the longitudinal drawing rate and the transverse drawing rate. Conversely, Re may be increased by increasing the difference. Re and Rth of the cellulose acylate film thus drawn preferably satisfy the following equations:

Rth≧Re

200 nm≧Re≧0 nm

500 nm≧Rth≧30 nm

more preferably

Rth≧Re×1.1

150 nm≧Re≧10 nm

400 nm≧Rth≧50 nm

and further preferably

Rth≧Re×1.2

100 nm≧Re≧20 nm

350 nm≧Rth≧80 nm

The angle formed between the film formation direction (longitudinal direction) and the delayed phase axis of Re of the film is preferably closer to 0°, +90° or −90°. To explain more specifically, in the longitudinal drawing, the angle is preferably closer to 0°. The angle is preferably 0°±3°, more preferably 0°±2°, and further preferably 0°±1°. In the case of the transverse drawing, the angle is preferably 90°±3° or −90°±3°, more preferably 90°±2° or −90°±2°, and further preferably 90±1° or −90±1°.

The thickness of the cellulose acylate film after drawing is 15 μm to 200 μm (both inclusive), more preferably 30 μm to 170 μm (both inclusive), and further preferably 40 μm to 140 μm (both inclusive). The difference in thickness in the longitudinal direction and width direction each is preferably 0% to 3% (both inclusive), more preferably 0% to 2% (both inclusive), and further preferably 0% to 1% (both inclusive).

The physical properties of the cellulose acylate film after drawing preferably fall within the following range.

The tensile elastic modulus is preferably 1.5 kN/mm² or more to less than 3.0 kN/mm 2, more preferably 1.7 kN/mm² to 2.8 kN/mm² (both inclusive) and further preferably 1.8 kN/mm² to 2.6 kN/mm² (both inclusive). The break (ductility) is preferably 3% to 100% (both inclusive), more preferably 5% to 80% (both inclusive), and further preferably 8% to 50% (both inclusive). Tg of the film (which refers to Tg of a mixture of cellulose acylate and additives) is preferably 95° C. to 145° C. (both inclusive), more preferably 100° C. to 140° C. (both inclusive), and further preferably 105° C. to 135° C. (both inclusive). The thermal dimensional change of the film at 80° C. per day both in the length and width directions is preferably 0% to ±1% (both inclusive), more preferably 0% to ±0.5% (both inclusive), and further preferably 0% to ±0.3% (both inclusive). The water permeability of the film at 40° C. at a relative humidity of 90% is preferably 300 g/m²/day to 1000 g/m²/day (both inclusive), more preferably 400 g/m²/day to 900 g/m²/day (both inclusive), and further preferably 500 g/m²/day to 800 g/m²/day (both inclusive). The equilibrium water content of the film at 25° C. at a relative humidity 80% is preferably 1% by mass to 4% by mass (both inclusive), more preferably 1.2% by mass to 3% by mass (both inclusive), and further preferably 1.5% by mass to 2.5% by mass (both inclusive). The thickness is 30 μm to 200 μm (both inclusive), more preferably 40 μm to 180 μm (both inclusive), and further preferably 50 μm to 150 μm (both inclusive). The haze is preferably 0% to 3% (both inclusive), more preferably 0% to 2% (both inclusive), and further preferably 0% to 1% (both inclusive).

The transmittance of the all optical light is preferably 90% or more, more preferably 91% or more, and further preferably 98% or more.

(9) Surface Treatment

Undrawn and drawn cellulose acylate films can be improved in adhesion to a functional layer such as an undercoating layer and a backing layer) by applying surface treatment thereto. Examples of the surface treatment include glow discharge treatment, ultraviolet irradiation treatment, corona treatment, flame treatment, acid treatment and alkali treatment. The glow discharge treatment may be use low-temperature plasma generating at a low pressure gas of 0.1 Pa to 3000 Pa (=10⁻³ to 20 Torr) or a plasma under the atmospheric pressure. A gas excited by a plasma under the aforementioned conditions, that is, a plasma excitation gas, which includes argon, helium, neon, krypton, xenon, nitrogen, carbon dioxide, fron such as tetrafluoromethane and mixtures thereof. These gases are described in Technical Report No. 2001-1745, published on Mar. 15, 2001 by the Japan Institution of Invention and Innovation, pages 30 to 32). In a plasma treatment performed under the atmospheric pressure recently drawn attention, an irradiation energy of 20 Kgy to 500 Kgy is used under 10 kev to 1000 kev, and more preferably an irradiation energy of 20 Kgy to 300 Kgy is used under 30 kev to 500 kev. Of the surface treatments mentioned above, alkali saponification is particularly preferable and effective for treating the surface of a cellulose acylate film. More specifically, the alkali saponification treatments described in Japanese Patent Application Laid-Open Nos. 2003-3266, 2003-229299, 2004-322928, and 2005-76088 may be employed.

In the alkaline saponification, a film may be soaked in a saponification solution or coated with a saponification solution. In the soaking method, a film is soaked in an aqueous solution of NaOH or KOH (pH 10 to 14) placed in a vessel heated to 20 to 80° C. for 0.1 to 10 minutes, neutralized, washed with water and dried.

Examples of the coating method include a dip-coating method, curtain coating method, extrusion coating method, bar coating method and E-type coating method. A solvent used in the alkali saponification coating solution preferably has good wettability in order to coat the saponification solution onto a transparent substrate and maintains the surface state in good conditions without forming convex-concave portions in the surface of the transparent substrate. More specifically, alcoholic solvent is preferable and isopropyl alcohol is particularly preferable. Alternatively, an aqueous surfactant solution may be used as a solvent. The alkali of the alkali saponification coating solution is preferably dissolved in the aforementioned solvent and KOH and NaOH are further preferable. The pH of the saponification coating solution is preferably 10 or more, and further preferably 12 or more. The alkaline saponification reaction is preferably performed at room temperature for 1 second to 5 minutes (both inclusive), further preferably 5 seconds to 5 minutes (both inclusive), and particularly preferably, 20 seconds to 3 minutes (both inclusive). After the alkali saponification reaction, the surface coated with the saponification solution is preferably washed with water or acid, and then, washed with water. The saponification coating treatment and removing coating from an orientation film (described later) can be continuously performed to reduce the number of production steps. These saponification methods are more specifically described in Japanese Patent Application Laid-Open No. 2002-82226 and WO02/46809.

An undercoating layer may be provided for adhering a cellulose acylate film to a functional layer. The undercoating layer may be coated after the surface treatment is performed or without performing the surface treatment. The undercoating layer is described in Technical Report No. 2001-1745, published on Mar. 15, 2001 by the Japan Institution of Invention and Innovation, page 32).

These surface-treatment and undercoating steps may be integrated in a final stage of the film formation unit or separately performed by itself. Alternatively, it can be performed in a functional layer imparting step (described later).

(10) Functional Layer

It is preferable that a functional layer, which is specifically described in Technical Report No. 2001-1745, published on Mar. 15, 2001 by the Japan Institution of Invention and Innovation, pages 32-45), is used in combination with drawn and undrawn cellulose acylate films according to the present invention. Of the functional layers described in the report, use preferably may be made of a polarizing layer (polarizer), optical compensation layer (optical compensation film) and antireflection imparting layer (anti-reflective film) and hard coating layer.

(i) Polarizing Layer (Formation of Polarizer)

Materials for Polarizing Layer

A polarizing layer presently on the market is generally formed by soaking a drawn polymer in a bath containing a solution of iodine or a dichromatic dye to impregnate a binder used in the polarizing layer with the iodine and dichromatic dye. Alternatively, a polarizing film formed by coating, for example, a polarizing film manufactured by Optiva Inc. may be used. The iodine and dichromatic dye in the polarizing film are orientationally ordered in the binder to express polarization. Examples of the dichromatic dye include an azo dye, stilbene dye, pyrazolone dye, triphenylmethane dye, quinoline dye, oxazine dye, thiazine dye and anthraquinone dye. The dichromatic dye is preferably water-soluble and preferably has a hydrophilic substituent such as sulfo, amino, hydroxyl groups. More specifically, use may be made of the compounds described in Technical Report No. 2001-1745, published on Mar. 15, 2001 by the Japan Institution of Invention and Innovation, page 58.

As the binder of the polarizing film, a self-crosslinkable polymer or a polymer crosslinkable with the aid of a crosslinking agent may be used. These binders may be used in combination. Examples of the binder include a methacrylate copolymer, styrene copolymer, polyolefin, polyvinyl alcohol, modified polyvinyl alcohol, poly(N-methylolacrylamide), polyester, polyimide, vinyl acetate copolymer, carboxymethylcellulose, and polycarbonate, which are described in, for example, Japanese Patent Application Laid-Open Nos. 8-338913 (the specification, paragraph [0022]). A silane coupling agent is also used as a polymer. As the polymer, use may be preferably made of a water-soluble polymer such as poly(N-methylolacrylamide), carboxymethylcellulose, gelatin, polyvinyl alcohol (PVA), and modified polyvinyl alcohol; more preferably gelatin, polyvinyl alcohol and modified polyvinyl alcohol; and most preferably, polyvinyl alcohol and modified polyvinyl alcohol. Particularly preferably, two types of polyvinyl alcohols or modified polyvinyl alcohols different in polymerization degree may be used in combination. Degree of saponification of polyvinyl alcohol is preferably 70% to 100%, and more preferably 80% to 100%. Degree of polymerization of a polyvinyl alcohol is preferably 100 to 5000. The modified polyvinyl alcohol is described in Japanese Patent Application Laid-Open Nos. 8-338913, 9-152509 and 9-316127. Not less than two types of polyvinyl alcohols and modified polyvinyl alcohols may be used in combination.

The lowermost limit of the thickness of the binder of the polarizing film is preferably 10 μm. The thinner the binder, the better in view of light leakage from a liquid crystal display device. Therefore, the uppermost limit of the thickness of the binder is preferably equal to or thinner than that of a polarizer now on the market (about 30 μm), more preferably 25 μm or less, and further preferably 20 μm or less.

The binder of the polarizing film may be crosslinked. A polymer or monomer having a crosslinkable functional group may be added to the binder or a self-crosslinkable functional group may be added to the binder polymer. Crosslinking may be mediated by light, heat or pH change. In this way, a binder having a crosslinking structure can be formed. As to the crosslinking agent, there is a description in the specification of U.S. reissued Pat. No. 23297. Alternatively, a boron compound such as boric acid and borax may be used as a crosslinking agent. The addition amount of a crosslinking agent to the binder is preferably 0.1% by mass to 20% by mass relative to the binder. If a crosslinking agent is added within the range, the orientation of a polarizing element and moist-heat resistance of the polarizing film can be satisfactory.

After compression of a crosslinking reaction, unreacted crosslinking agent preferably remains in an amount of not more than 1.0% by mass, and more preferably not more than 0.5% by mass. If this condition is satisfied, the weather resistance of the polarizing film can be improved.

[Drawing of Polarizing Film]

A polarizing film is preferably stained with iodine or a dichromatic dye after it is drawn (drawing method) or rubbed (rubbing method).

In the drawing method, the draw ratio of a polarizing film is preferably 2.5 to 30.0 fold, and more preferably 3.0 to 10.0 fold. A film may be drawn in the air (dry drawing) or by soaking in water (wet drawing). The draw ratio of the film is preferably 2.5 to 5.0 fold in the dry drawing and 3.0 to 10.0 fold in the wet drawing. The drawing is performed in the parallel to the machine direction (parallel drawing) or diagonally (diagonal drawing). The drawing may be performed in a single step or a plurality of steps. Drawing performed in a plurality of steps is advantageous since the film is drawn uniformly even if the draw ratio is high. More preferably drawing is performed diagonally by tilting the film at an angle of 10° to 80°

(I) Parallel drawing

Prior to drawing, a PVA film is swollen. Degree of swelling is 1.2 fold to 2.0 fold (the mass ratio before swelling to after swelling). Thereafter, the PVA film is (continuously) fed via guide rolls and the like to a bath containing an aqueous medium or a dichromatic dye, in which the PVA film is drawn at a temperature of 15° C. to 50° C., preferably 17° C. to 40° C. The film is held by two pairs of nip rolls and drawn by rotating nip rolls such that the pair of nip rolls arranged downstream rotates faster than those arranged upstream. The draw rate refers to the ratio in length of the drawn film to the initial undrawn film (the same definition is used hereinafter). A preferably draw rate in view of the functional effects mentioned above is 1.2 fold to 3.5 fold, and more preferably 1.5 fold to 3.0 fold. After that, the drawn film is dried at 50° C. to 90° C. to obtain a polarizing film.

(II) Diagonal Drawing

A diagonal drawing method is described in Japanese Patent Application Laid-Open No. 2002-86554. In this method, a film is drawn diagonally by use of a tenter extending in the diagonal direction. Since a film is drawn in the air, the film must be impregnated with water in advance to make it easier to draw. The water content of the film is preferably 5% to 100% (both inclusive). The drawing is preferably performed at a temperature of 40° C. to 90° C. and at a relative humidity of 50% to 100% (both inclusive).

The absorption axis of the polarizing film thus obtained is preferably 10° to 80°, more preferably 30° to 60°, and further preferably 45° (40° to 50°) substantially.

[Adhesion]

After saponification, drawn or undrawn cellulose acylate film is adhered to a polarizing layer (film) to form a polarizer. The adhesion directions of the films are not particularly limited; however, the two films are preferably adhered such that the flow-casting axis (direction) of the cellulose acylate film is crossed with the drawing direction of the polarizing layer (film) at an angle with 0°, 45° or 90°.

The adhesive agent to be used herein is not particularly limited; however, includes a PVA resin (including a PVA modified with an acetoacetyl group, sulfonic acid group, carboxyl group, and oxyalkylene group) and an aqueous solution of boron compound. Of them, a PVA resin is preferable. The thickness of the adhesive agent layer is preferably 0.01 μm to 10 μm, and particularly preferably, 0.05 μm to 5 μm after dry.

Examples of the structure of the adhesion layer include:

### i) A/P/A

### ii) A/P/B

iii) A/P/T

### iv) B/P/B

### v) B/P/T

Note that A denotes an undrawn film according to the present invention; B a drawn film according to the present invention; T a cellulose triacetate film (Fujitack: trade name); P a polarizing layer. In the structures of i) and ii), A and B may be cellulose acetate films same or different in composition. In the case of iv), B and B may be cellulose acetate films same or different in composition and draw rate. Furthermore, when the adhesion layer is integrated into a liquid crystal display device, which side of the adhesion layer may be used at the side of a liquid crystal surface. In the cases of ii) and v), B is preferably arranged at the liquid crystal surface side.

When a polarizer is integrated into a liquid crystal display device, a substrate containing a liquid crystal is generally arranged between two polarizers. However, polarizers i) to v) according to the present invention and the general polarizer (T/P/T) may be freely combined. However, on the outermost display surface of the liquid crystal display device, a film such as a transparent hard coating layer, glare filter layer, and anti-reflective layer (as described later) may preferably be provided.

The higher the light transmittance of the polarizer thus obtained the more preferable. The higher the degree of polarization, the more preferable. The light transmittance of light having a wavelength of 550 nm through the polarizer preferably falls within the range of 30% to 50%, more preferably 35% to 50%, and most preferably, 40% to 50%. Degree of polarization of light having a wavelength of 550 nm through the polarizer preferably falls within the range of 90% to 100%, more preferably 95% to 100%, and most preferably, 99% to 100%.

When the polarizer thus obtained is stacked on a λ/4 board, circular polarization can be obtained. In this case, they are stacked such that the delayed phase axis of the λ/4 board and the absorption axis of the polarizer form an angle of 45°. At this time, the λ/4 board is not particularly limited; however, a λ/4 board having wavelength-dependent retardation (retardation decreases as the wavelength of light decreases). Furthermore, a polarizing film (polarizer) having an absorption axis tilted by 20° to 70° relative to the longitudinal direction and a λ/4 board formed of an optical anisotropic layer composed of a liquid crystal compound are preferably used.

A protecting film may be adhered to one of the surfaces of the polarizer, and a separating film to the other surface. The protecting film and the separating film are used in order to protect the polarizer when it is shipped and inspected.

(ii) Provision of Optical Compensation Layer (Formation of Optical Compensation Film)

An optical anisotropic layer serves for compensating a liquid crystal compound in a liquid crystal cell indicating black in a liquid crystal display device. The optical anisotropic layer is provided by forming an orientation film on a drawn or undrawn cellulose acylate film and further adding an optical anisotropic layer thereto.

[Orientation Film]

An orientation film is provided on a drawn or undrawn cellulose acylate film after the surface of the cellulose acylate film is treated. The orientation film plays a role in regulating the orientation direction of liquid crystal molecules. However, if liquid crystal molecules are orientationally ordered and then the orientation direction is fixed, the orientation film, which plays the same role as mentioned, is not required as an essential structural element. In short, a polarizer according to the present invention can be formed by transferring only an optical anisotropic layer, which is formed on the orientation film whose orientation state is fixed, onto a polarizer.

The orientation film can be formed by rubbing an organic compound (preferably a polymer), obliquely depositing an inorganic compound, forming a layer having a micro groove, or accumulating an organic compound (such as ω-tricosanoic acid, dioctadecyl-methylammonium chloride, methyl stearate) by the Langmuir Brojet method (LB film). Alternatively, an orientation film is known to exhibit orientation by applying an electric field or magnetic filed, or light irradiation.

The orientation film is preferably formed by rubbing a polymer. The polymer to be used in the orientation film is principally has a molecular structure capable of inducing orientational ordering of liquid crystal molecules.

In the present invention, the polymer having molecular structure capable of inducing orientational ordering of liquid crystal molecules is preferred to further has a side chain having a crosslinkable group (e.g., double bond) bound to the main chain, or a crosslinkable group capable of inducing orientational ordering of liquid crystal molecules introduced into a side chain.

The polymer to be used in the orientation film may be either a self-crosslinkable polymer or a polymer crosslinkable with the aid of a crosslinking agent. These polymers may be used in various combinations. Examples of these polymers include methacrylate copolymers, styrene copolymers, polyolefins, polyvinyl alcohol, modified polyvinyl alcohols, poly(N-methylolacrylamide), polyesters, polyimides, vinyl acetate copolymers, carboxymethylcellulose, and polycarbonates, which are described in, for example, Japanese Patent Application Laid-Open Nos. 8-338913 (the specification, paragraph [0022]). A silane coupling agent is also used as a polymer. A water-soluble polymer such as poly(N-methylolacrylamide), carboxymethylcellulose, gelatin, polyvinyl alcohol, and modified polyvinyl alcohols is preferably used. More preferably gelatin, polyvinyl alcohol and modified polyvinyl alcohols are used, and most preferably, polyvinyl alcohol and modified polyvinyl alcohols are used. Particularly preferably, two types of polyvinyl alcohols or modified polyvinyl alcohols different in polymerization degree may be used in combination. Degree of saponification of polyvinyl alcohol is preferably 70% to 100%, and more preferably 80% to 100%. Degree of polymerization of a polyvinyl alcohol is preferably 100 to 5000.

The side chain inducing orientational ordering of liquid crystal molecules generally has a hydrophobic group as a functional group. The type of a functional group actually used is determined depending upon the type of liquid crystal molecules and desired orientational ordering state. To explain more specifically, as a modification group for a modified polyvinyl alcohol may be introduced by a copolymerization reaction (copolymerization modification), chain transfer reaction (chain transfer modification) or a block polymerization reaction (block polymerization modification). Examples of the modification group include a hydrophilic group such as a carboxylic acid group, a sulfonic acid group, a phosphonic acid group, an amino group, an ammonium group, an amide group, and a thiol group; a hydrocarbon group having 10 to 100 carbon atoms; a hydrocarbon group having a fluorine atom substituent; a thioether group; a polymerizable group such as an unsaturated polymerizable group, an epoxy group, an aziridinyl group; and an alkoxy silyl group such as trialkoxy, dialkoxy, and monoalkoxy. Specific examples of these modified polyvinyl alcohols are described in, for example, Japanese Patent Application Laid-Open No. 2000-155216 (the specification, paragraphs [0022] to [0145]); and Japanese Patent Application Laid-Open No. 2002-62426 (the specification, paragraphs [0018] to [0022]).

When a side chain having a polymerizable functional group is bonded to the main chain of the polymer of an orientation film or when a crosslinkable function group is introduced into a side chain capable of inducing orientational ordering of liquid crystal molecules, the polymer of the orientation film and a multifunctional monomer contained in an optical anisotropic layer can be copolymerized. As a result, tight covalent bond is formed not only between a multifunctional polymer and a multifunction polymer but also between an orientation-film polymer and an orientation film polymer, as well as between a multifunctional monomer and an orientation-film polymer. Accordingly, introduction of a crosslinkable functional group into an orientation-film polymer remarkably improves the strength of an optical compensation film.

The crosslinkable functional group of the orientation-film polymer preferably contains a polymerizable group, similarly to a multifunctional monomer. Examples of the polymerizable group are described in, for example, Japanese Patent Application Laid-Open No. 2000-155216 (the specification, paragraphs [0080] to [0100]). The orientation-film polymer can be crosslinked with the aid of a crosslinking agent in place of using the crosslinkable functional group mentioned above.

Examples of the crosslinking agent include aldehyde, N-methylol compound, dioxane derivative, a compound which functions by activating carboxyl group, activated vinyl compound, activated halogen compound, isooxasol and dialdehyde starch. Not less than two types of crosslinking agents may be used together. Specific examples of the crosslinking agents are described in, for example, Japanese Patent Application Laid-Open No. 2002-62426 (the specification, paragraphs [0023] to [024]). Of them, highly reactive aldehyde, in particular, glutaraldehyde is preferable.

The addition amount of the crosslinking agent is preferably 0.1% by mass to 20% by mass, and more preferably 0.5% by mass to 15% by mass. The amount of crosslinking agent remaining unreacted in an orientation film is preferably not more than 1.0% by mass, and more preferably not more than 0.5% by mass. By limiting the addition amount of the crosslinking agent in this way, the orientation film acquires sufficient durability without generating reticulation, even if it is used in a liquid crystal display device for a long term and allowed to leave under a high-temperature and high-humidity atmosphere for a long time.

An orientation film is basically formed by applying a coating solution, which contains the polymer serving as an orientation film forming material and a crosslinking agent, onto a transparent substrate, heating it to dry (crosslinked), and rubbing the resultant polymer. The crosslinking reaction may be performed at any time after the coating solution is applied onto the transparent substrate. When a water-soluble polymer such as polyvinyl alcohol is used as the orientation film forming material, a mixture of an organic solvent (e.g., methanol) having a defoaming function and water is preferably used as the coating solution. The ratio of water to the organic solvent (methanol) is preferably 0:100 to 99:1 in terms of mass ratio, and more preferably 0:100 to 91:9. Use of the solvent mixture suppresses generation of bubbles, markedly reduces defects in the surface of the orientation film as well as the optical compensation layer (film).

As a coating method for the orientation film, mention may be preferably made of a spin coating method, dip coating method, curtain coating method, extrusion coating method, rod coating method and roll coating method. Of them, the rod coating method is particularly preferable. The thickness of the orientation film after dry is preferably 0.1 μm to 10 μm. Dry heating may be performed at 20° C. to 110° C. To obtain sufficient crosslinking, dry heating is preferably performed at a temperature of 60° C. to 100° C., and particularly preferably, 80° C. to 100° C. The dry-heating may be performed for 1 minute to 36 hours, and preferably, 1 minute to 30 minutes. The pH of the coating solution is preferably set at an optimal value depending upon the crosslinking agent to be used. When glutaraldehyde is used, the pH of the coating solution is preferably 4.5 to 5.5, in particularly, preferably about 5.

The orientation film is provided on a drawn or undrawn cellulose acylate film or on the undercoating layer mentioned above. The orientation film is obtained by crosslinking the polymer layer, followed by rubbing the surface of the polymer layer.

As the rubbing treatment, a rubbing method widely used in an orientational ordering step for a liquid crystal display (LCD) may be used. To explain more specifically, the surface of the film to be orientationally ordered is rubbed in a predetermined direction with paper, gauge, felt, rubber, nylon fiber or polyester fiber to make the film orientationally ordered. In general, a film can be orientationally ordered by rubbing the surface of the film for several times with cloth in which fibers same in length and thickness are uniformly planted.

When rubbing is performed on an industrial scale, a rotatory rubbing roll is brought into contact with a film having a polarizing layer attached thereto while transferring it. The rubbing roll preferably has a roundness, cylindricity, and deflection within 30 μm or less. The film preferably comes into contact with the rubbing roll with an angle (rubbing angle) of 0.1° to 90°. However, as described in Japanese Patent Application Laid-Open No. 8-160430, stable rubbing treatment can be performed by winding the film around (3600 or more) the rubbing roll. The transfer speed of the film is preferably 1 m/min to 100 m/min. It is preferable that the rubbing angle appropriately falls within the range of 0° to 60°. When the film is used in a liquid crystal display device, the rubbing angle is preferably 40° to 50°, and particularly preferably, 45°.

The thickness of the orientation film thus obtained preferably falls within the range of 0.1 μm to 10 μm.

Next, the crystal liquid molecules of an optical anisotropic layer are orientationally ordered on the orientation film. Thereafter, if necessary, the orientation-film polymer is allowed to react with a multifunctional monomer contained in the optical anisotropic layer or crosslinked with the aid of a crosslinking agent.

Examples of the liquid crystal molecule for use in the optical anisotropic layer include a rod-form liquid crystal molecule and a discotic liquid crystal molecule. The rod-form liquid crystal molecule and discotic liquid crystal molecule may be high-polymer liquid crystal or low molecule liquid crystal and also include low molecule liquid crystal, which no longer exhibits the feature of liquid crystal due to crosslinking taking place therein.

[Rod-Form Liquid Crystal Molecule]

As the rod-form liquid crystal molecule, use may be preferably made of azomethines, azoxys, cyano biphenyls, cyanophenyl esters, benzoic acid esters, cyclohexanecarboxylic acid phenyl esters, cyanophenyl cyclohexanes, cyano-substituted phenyl pyrimidines, alkoxy substituted phenyl pyrimidines, phenyl dioxanes, tolanes and alkenyl cyclohexyl benzonitriles.

Note that the rod-form liquid crystal molecule includes a metal complex. A liquid crystal polymer containing a rod-form liquid crystal molecule in a repeat unit may be used as a rod-form liquid crystal molecule. In other words, the rod-form liquid crystal molecule may be bonded to a (liquid crystal) polymer.

As to the rod-form liquid crystal molecule, there is a description in Quarterly Review of Chemistry. Vol. 22, Chemistry of liquid crystal, 1994, edited by the Chemical Society of Japan (Chapters 4, 7 and 11); and liquid crystal display device handbook edited by the Japan Society for the Promotion of Science, the 142nd committee (Chapter 3).

The birefringence index of the rod-form liquid crystal molecule preferably falls within the range of 0.001 to 0.7.

The rod-form liquid crystal molecule preferably has a polymerizable group to fix the orientation state. As the polymerizable group, a radial polymerizable unsaturated group or a cationic polymerizable group is preferable. Examples of the polymerizable group include polymerizable groups and polymerizable liquid crystal compounds described in Japanese Patent Application Laid-Open No. 2002-62427 (the specification, paragraphs [0064] to [0086]).

[Discotic Liquid Crystal Molecule]

Examples of the discotic liquid crystal molecule include a benzene derivative described in a research report by C. Destrade et al. (Mol. Cryst. Vol. 71, page 111 (1981); torxene derivative described in a research report by C. Destrade et al., Mol. Cryst. Vol. 122, page 141 (1985), Physics lett, A, Vol. 78, page 82 (1990); a cyclohexane derivative described in a research report by B. Kohne et al. Angew. Chem., Vol. 96, page 70 (1984), azacrown based and phenyl acetylene based macrocycles described in research reports by M. Lehn et al. (J. Chem. Commun., page 1794 (1985) and J. Zhang et al., J. Am. Chem. Soc. Vol. 116, page 2655 (1994).

The discotic liquid crystal molecule include a liquid crystal compound having a structure in which a straight chain alkyl group, alkoxy group, and substituted benzoyl oxy group are substituted radially as side chains of a molecule center, mother nucleus. The discotic liquid crystal molecule is preferably a molecule or molecular aggregate having a rotation symmetric structure and a tendency of orientationally ordering in a certain direction. The discotic liquid crystal molecule forming the optical anisotropic layer is not necessary to keep the properties of the discotic liquid crystal molecule to the end. To explain more specifically, low-molecular weight discotic liquid crystal molecule, since it has a reactive group with heat or light, initiates a polymerization reaction or crosslinking reaction by heat or light, converting into a polymer and thus loses liquid crystal properties. Therefore, the optical anisotropic layer may contain such a low molecular-weight discotic liquid crystal molecule no longer having liquid crystallinity. Preferable examples of the discotic liquid crystal molecules are described in Japanese Patent Application Laid-Open No. 8-50206. Furthermore, the polymerization of the discotic liquid crystal molecules is described in Japanese Patent Application Laid-Open No. 8-27284.

To fix the discotic liquid crystal molecule by polymerization, it is necessary to bind a polymerizable group serving as a substituent to the discotic core of the discotic liquid crystal molecule. Compounds in which the discotic core and the polymerizable group bind via a linkage group are preferable, which allows the orientation state to be kept liquid crystal molecule compound even if a polymerization reaction takes place. Examples of the discotic liquid crystal molecules compound are described in Japanese Patent Application Laid-Open No. 2000-155216 (the specification, paragraphs [0151] to [0168]).

In hybrid orientation, the angle formed between the longitudinal axis (disk surface) of the discotic liquid crystal molecule and the surface of a polarizing film increases or decreases with an increase of the distance from the polarizing film in the depth direction of an optical anisotropic layer. The angle preferably decreases with an increase of the distance. The angle may continuously increased, continuously decreased, intermittently increased, intermittently decreased, varies (including continuous increase and continuous decrease), or intermittently varies (including an increase and decrease). The term “intermittently varies” refers to the case where the tilt angle does not change in a certain region in the middle of the thickness direction. The tilt angle may increase or decrease as a whole even though there is a region where the tilt angle does not change. Furthermore, it is preferable that the tilt angle continuously changes.

The average direction of the longitudinal axes of discotic liquid crystal molecules at the side of a polarizing film can be controlled by selecting the discotic liquid crystal molecules or a material for the orientation film or selecting a rubbing method. On the other hand, the average direction of the longitudinal axes of discotic liquid crystal molecules at the surface side (exposed to the air) can be controlled by selecting the discotic liquid crystal molecules or a type of an additive(s) used together with the discotic liquid crystal molecules. Examples of the additive(s) used together with the discotic liquid crystal molecules include a plasticizer, surfactant, polymerizable monomer and polymer. The degree of change in orientation direction along the longitudinal axis can be controlled by selecting the liquid crystal molecules and additives in the same manner as described above.

[Optical Anisotropic Layer and Other Composition]

The uniformity and strength of a coating film and the orientation of liquid crystal molecules can be improved by using additives such as a plasticizer, surfactant, polymerizable monomer together with the liquid crystal molecules. These additives is preferred to have compatibility with the liquid crystal molecules and vary the tilt angles of the liquid crystal molecules or do not inhibit the orientation of the molecules.

As the polymerizable monomer, a radical polymerizable compound or cationic polymerizable compound may be mentioned. A preferable compound is a multifunctional radical polymerizable monomer, which is copolymerizable with a liquid crystal compound containing the polymerizable group as mentioned above. Specific examples of the polymerizable monomer are described in Japanese Patent Application Laid-Open No. 2002-296423 (the specification, paragraphs [0018] to [0020]). The addition amount of the polymerizable compound generally falls within the range of 1% by mass to 50% by mass relative to the discotic liquid crystal molecules and preferably within the range of 5% by mass to 30% by mass.

As the surfactant, a known compound in the art may be mentioned, in particular, a fluorine compound is preferable. Specific examples of the surfactant are described in Japanese Patent Application Laid-Open No. 2001-330725 (the specification, paragraphs [0028] to [0056]).

The polymer to be used together with a discotic liquid crystal molecule preferably changes the tilt angle of the discotic liquid crystal molecule.

As an example of the polymer, a cellulose ester may be mentioned. Preferable examples of the cellulose ester are described in Japanese Patent Application Laid-Open No. 2000-155216 (the specification, paragraph [0178]). The polymer is added so as not to inhibit the orientational ordering of the liquid crystal molecules. The addition amount of the polymer preferably fall within the range of 0.1% by mass to 10% by mass relative to the liquid crystal molecules and preferably within the range of 0.1% by mass to 8% by mass.

The transition temperature of a discotic nematic liquid crystal phase of the discotic liquid crystal molecule to a solid phase is preferably. 70° C. to 300° C., and further preferably 70° C. to 170° C.

[Formation of Optical Anisotropic Layer]

The optical anisotropic layer is formed by applying a coating solution, which contains a liquid crystal molecule and a polymerization initiator (described later) and arbitrary components as needed, onto an orientation film.

As the solvent to be used in the coating solution, an organic solvent is preferably used. Examples of the organic solvent include an amide such as N, N-dimethylformamide; sulfoxide such as dimethylsulfoxide; heterocyclic compound such as pyridine; hydrocarbon such as benzene; hexane; alkylhalide such as chloroform, dichloromethane, and tetrachloroethane; ester such as methyl acetate and butyl acetate; ketone such as acetone and methylethyl ketone; and ether such as tetrahydrofuran and 1,2-dimethoxyethane. Of them, an alkylhalide and a ketone are preferable. Two or more types of organic solvents may be used in combination.

The coating solution may be applied by a known method such as wire bar coating, extrusion coating, direct-gravure coating, reverse gravure coating, and dye-coating methods.

The thickness of the optical anisotropic layer is preferably 0.1 μm to 20 μm, more preferably 0.5 μm to 15 μm, and most preferably, 1 μm to 10 μm.

[Fixation of Orientation State of Liquid Crystal Molecules]

The liquid crystal molecules orientationally ordered whose orientation state can be maintained and fixed. The fixation can be performed by a polymerization reaction. Examples of the polymerization reaction include a thermal polymerization reaction using a thermal polymerization initiator and a photopolymerization reaction using a photopolymerization initiator. Of them, the photopolymerization reaction is preferable.

Examples of the photopolymerization initiator include α-carbonyl compounds (described in the specifications of U.S. Pat. Nos. 2,367,661 and 2,367,670); an acyloin ether (described in the specification of U.S. Pat. No. 2,448,828); α-hydrocarbon substituted aromatic acyloin ether (described in the specification of U.S. Pat. No. 2,722,512); multinuclear quinone compound (described in the specifications of U.S. Pat. Nos. 3,046,127 and 2951758); use of triallyl-imidazolyl dimer and p-aminophenyl ketone (described in the specification of U.S. Pat. No. 3,549,367); acridine and phenazine compound (described in the specifications of Japanese Patent Application Laid-Open No. 60-105667, U.S. Pat. No. 4,239,850); and oxadiazole compound (described in the specifications of U.S. Pat. No. 4,212,970).

The amount of the photopolymerization initiator to be used preferably falls within the range of 0.01% by mass to 20% by mass relative to the solid matter of a coating solution, and more preferably within the range of 0.5% by mass to 5% by mass.

As light irradiation for polymerizing liquid crystal molecules, ultraviolet rays are preferably used. Irradiation energy preferably falls within the range of 20 mJ/cm² to 50 J/cm², more preferably within the range of 20 mJ/cm² to 5000 mJ/cm², and further preferably 100 mJ/cm² to 800 mJ/cm². To accelerate the photopolymerization reaction, light may be irradiated while heating. A protecting layer may be provided on the optical anisotropic layer.

It is preferable that the optical compensation film and the polarizing layer may be used in combination. To explain more specifically, a coating solution for the optical compensation film is applied onto the surface of the polarizing layer to form an optical anisotropic layer. As a result, since a polymer film is not used between the polarizing film and the optical anisotropic layer, a polarizer reduced in thickness can be obtained. In such a polarizer, stress (strain×sectional area×elastic modulus) produced by dimensional change of the polarizing film is small. When the polarizer according to the present invention is attached to a large liquid crystal display device, a high definition image can be obtained without causing a light leakage problem.

Drawing is performed such that a tilt angle between the polarizing layer and the optical compensation layer becomes consistent with the angle between transmission axes of two polarizers, which are to be adhered to both sides of liquid crystal cells constituting a LCD, and the longitudinal direction or transverse direction of liquid crystal cells. The tilt angle is generally 45°. However, in transmission type, reflection type and semi-transmission type LCD devices recently developed, the tilt angle is not always 45°. The drawing direction is preferably adjusted flexibly in accordance with the design of an LCD.

[Liquid Crystal Display Device]

Each of liquid crystal modes using an optical compensation film will be explained.

(TN Mode Liquid Crystal Display Device)

A TN mode liquid crystal display device is most frequently used as a color TFT liquid crystal display device and described in many documents. In the orientation state of a liquid crystal cell indicating black in the TN mode, rod-form liquid crystal molecules rise in the middle of a cell, whereas the rod-form liquid crystal molecules lie down in the cell near the substrate.

(OCB Mode Liquid Crystal Display Device)

This is a liquid crystal cell of a bent orientation mode in which rod-form liquid crystal molecules arranged in the upper portion are orientationally ordered in a reverse direction (symmetrically) to those arranged in the lower portion of a liquid crystal cell. Such a liquid crystal display device employing liquid crystal cells of a bend-orientation mode is disclosed in the specifications of U.S. Pat. Nos. 4,583,825 and 5,410,422. Since the rod-form liquid crystals molecules arranged in the upper portion are orientationally ordered symmetrically to those of the lower portion, the bend orientation mode liquid crystal cells has self-optical compensation function. For this reason, the liquid crystal mode is also called as the OCB (optically compensatory bend) mode.

In the OCB mode as well as the TN mode, the liquid crystal cell appearing black has an orientational order state where rod form liquid crystal molecules stand up in the center of the cell, whereas lie down in close proximity to the substrate.

(VA Mode Liquid Crystal Display Device)

The VA mode liquid crystal display device is characterized in that rod-form liquid crystal molecules are orientationally ordered substantially vertically when no voltage is applied. Examples of the VA mode liquid crystal cell include

(1) a VA (vertical orientation mode liquid crystal cell of narrow definition in which rod-form liquid crystal molecules are orientationally ordered substantially vertically at no voltage application time and ordered substantially horizontally at voltage application time (described in Japanese Patent Application Laid-Open No. 2-176625);

(2) an MVA (multi-domain vertical orientation) mode liquid crystal cell with an enlarged viewing angle (described in SID97, Digest of tech. Papers (abstract) 28 (1997) p. 845);

(3) a liquid crystal cell of n-ASM (Axially Symmetric Oriented Microcell) mode in which rod form liquid crystal molecules are orientationally ordered substantially vertically at no voltage application time and orientationally ordered in a twisted nematic multi-domain mode (Japanese liquid crystal symposium (abstract), p 58-59 (1998)).

(4) liquid crystal cell of a SURVAIVAL mode (announced in LCD international 98).

(IPS Mode Liquid Crystal Display Device)

The IPS mode liquid crystal display device is characterized in that rod-form liquid crystal molecules are orientationally ordered substantially horizontally in plane. The orientation of the liquid crystal molecules is changed and switched by on and off of voltage application. Specific examples of the IPS mode liquid crystal display device are described in Japanese Patent Application Laid-Open Nos. 2004-365941, 2004-12731, 2004-215620, 2002-221726, 2002-55341, and 2003-195333.

[Other Liquid Crystal Display Devices]

In the same manner as above, optical compensation can be performed when ECB (Electronic Codebook)mode and STN (Supper Twisted Nematic) mode, FLC (Ferroelectric Liquid Crystal) mode, AFLC (Anti-ferroelectric Liquid Crystal) mode, and ASM (Axially Symmetric Oriented Microcell) mode are used. Furthermore, a cellulose acylate resin film according to the present invention is effective in each of transmission type, reflective type and semi-transmission type liquid crystal display devices. A cellulose acylate resin film according to the present invention is effectively used as an optical compensation sheet for a reflective type liquid crystal display device of GH (Guest-Host) type.

These cellulose resin films mentioned above are specifically described in Technical Report No. 2001-1745, published on Mar. 15, 2001 by the Japan Institution of Invention and Innovation, pages 45 to 59).

Provision of Anti-Reflective Layer (Anti-Reflective Film)

The anti-reflective film is formed by forming a low reflective layer serving as an antifouling layer and at least one of layer (i.e., high reflective layer and medium reflective layer) having a higher reflective index than the low reflective layer on a transparent substrate.

The anti-reflective film is a multi-layered film of transparent thin films having different reflective indexes. Each of the thin films is formed by depositing an inorganic compound (metal oxides, etc.) by a chemical vapor deposition (CVD) method or physical vapor deposition (PVD) method. On the multiple layered thin film, a coating film of colloidal metal oxide particles is formed by a sol-gel method for a metal compound such as a metal alkoxide, followed by applying post treatment thereto (UV ray irradiation: Japanese Patent Application Laid-Open No. 9-157855; and plasma treatment: Japanese Patent Application Laid-Open No. 2002-327310).

On the other hand, as an anti-reflective film having a high productivity, various types of anti-reflective films formed by stacking thin films having inorganic particles dispersed in the matrix are proposed.

An anti-reflective film formed by coating and having anti-grazing properties may be mentioned, which has minute convex and concave portions in the uppermost anti-reflecting layer.

A cellulose acylate film according to the present invention can be applied to any type of anti-reflective film, and particularly preferably, applied to an anti-reflective film formed by coating.

[Layer Structure of Coating Type Anti-Reflective Film]

The structure of the anti-reflective film is constituted of a medium refractive layer, high refractive layer and low refractive layer (outermost layer) stacked on a substrate and designed such that the refractive indexes of these layers satisfy the following relationship:

The refractive index of the high refractive index>the refractive index of the medium refractive index>the refractive index of the transparent substrate>the refractive index of the low refractive index. Furthermore, a hard-coat layer may be provided between the transparent substrate and the medium refractive layer.

Moreover, the anti-reflective film may be formed of a medium refractive hard coat layer, high refractive layer and low refractive layer.

Examples of the anti-reflective film are described in Japanese Patent Application Laid-Open Nos. 8-122504, 8-110401, 10-300902, 2002-243906 and 2000-111706. Furthermore, another function may be imparted to each of the layers. For example, a low refractive layer having antifouling properties and a high refractive index having anti-statistic properties may be mentioned (e.g., Japanese Patent Application Laid-Open Nos. 10-206603 and 2002-243906).

The haze of the anti-reflective film is preferably 5% or less, and more preferably 3% or less. The strength of the anti-reflective film is preferably “1H” or more based on the pensile hardness test according to JIS K5400, more preferably “2H” or more, and most preferably, “3H” or more.

[High Refractive Layer and Medium Refractive Layer]

The high refractive layer of the anti-reflective film is formed of a hardened film containing at least ultra-fine inorganic particles of 100 nm or less in average particle size and a high refractive index and a matrix binder.

The ultra-fine inorganic particles having a high refractive index are formed of an inorganic compound having a refractive index of 1.65 or more, and preferably 1.9 or more. Examples of the inorganic compound include oxides of Ti, Zn, Sb, Sn, Zr, Ce, Ta, La and In and oxide complexes containing these metal atoms.

To obtain such ultra-fine particles, the following contrivances may be made: The surface of the particles is treated by a surface treatment agent such as silane coupling agents (Japanese Patent Application Laid-Open Nos. 11-295503 and 11-153703, and 2000-9908), anionic compounds, or organic metal coupling agents (Japanese Patent Application Laid-Open No. 2001-310432); Particles are formed so as to have a core shell structure by placing high refractive particles at the center (e.g., Japanese Patent Application Laid-Open No. 2001-166104); and a specific dispersion agent is used in combination (e.g., Japanese Patent Application Laid-Open Nos. 11-153703 and 2002-2776069 and U.S. Pat. No. 6,210,858B1).

As a material for forming a matrix, a thermoplastic resin and thermosetting resin known in the art may be mentioned.

Furthermore, (as a material for forming a matrix), it is preferable to use at least one type of composition selected from the group consisting of a composition containing a multifunctional compound having at least two polymerizable groups (radical polymerizable and/or cationic polymerizable groups), a composition containing an organic metal compound having a hydrolysable group and a composition containing its partial condensation product of organic metal compound (see, for example, Japanese Patent Application Laid-Open Nos. 2000-47004, 2001-315242, 2001-31871, and 2001-296401).

Furthermore, a hardened film formed of a colloidal metal oxide, which is obtained from a hydrolytic condensation product of a metal alkoxide, and a metal alkoxide composition is preferably used as the high refractive layer (for example, described in Japanese Patent Application Laid-Open No. 2001-293818).

The refractive index of the high refractive layer is generally 1.70 to 2.20. The thickness of the high refractive layer is 5 nm to 10 μm, and more preferably 10 nm to 1 μm.

The refractive index of the medium refractive layer is adjusted so as to fall between the refractive index of the lower refractive layer and that of the high refractive layer. The refractive index of the medium refractive layer is preferably 1.50 to 1.70.

[Low Refractive Layer]

The low refractive layer is formed by lamination on the high refractive layer. The refractive index of the low refractive layer is 1.20 to 1.55, and preferably 1.30 to 1.50.

The low refractive layer is preferably formed as the outermost layer having anti-scratch properties and antifouling properties. To greatly improve the anti-scratch properties, it is effective that the surface of the low refractive layer is formed smooth. To impart smoothness, a technique known in the art for introducing silicon and fluorine into a thin film may be employed.

The refractive index of a fluorine-containing compound is preferably 1.35 to 1.50, and more preferably 1.36 to 1.47. As the fluorine-containing compound, a compound containing a fluorine atom within the range of 35% by mass and 80% by mass and containing preferably a crosslinkable or polymerizable functional group.

Examples of the fluorine-containing compound are described in Japanese Patent Application Laid-Open Nos. 9-222503 (the specification, paragraphs [0018] to [0026]), 11-38202 (the specification, paragraphs [0019] to [0030]), 2001-40284 (the specification, paragraphs [0027] to [0028]) and 2000-284102.

Silicone is a compound having a polysiloxane structure may be mentioned. Of the silicone compounds, a preferably silicone compound is a polymer having a hardenable functional group or a polymerizable function group in the polymer chain and forms a crosslinking bridge in a film. Examples of such a silicone compound include reactive silicone (e.g., Silaplane (trade name) manufactured by Chisso Corporation) and polysiloxane having a silanole group at both ends (see Japanese Patent Application Laid-Open No. 11-258403).

The crosslinking or polymerization reaction of a fluorine containing compound and/or a siloxane polymer having a crosslinkable or polymerizable group is preferably performed by light irradiation or heat application, which is performed simultaneously with or after application of a coating composition containing a polymerization initiator and a sensitizer for forming the outermost layer.

As the low refractive layer, a sol-gel hardened film is preferable. The sol-gel hardened film is formed by hardening an organic metal compound such as a silane coupling agent and a silane coupling agent containing a predetermined fluorine containing hydrocarbon group in the presence of a catalyst through a condensation reaction. For example, mention may be made of silane compounds containing a fluoroalkyl group or its partial hydrolysis condensation products (described in Japanese Patent Application Laid-Open Nos. 58-142958, 58-147483, 58-147484, 9-157582, 11-106704), and silyl compounds containing a poly[perfluoroalkylether] group, which is a long-chain group containing fluorine (described in Japanese Patent Publication Laid-Open Nos. 2000-117902, 2001-48590, and 2002-53804).

The low refractive layer may contain, other than the aforementioned additives, additives including a filler, which may be a low-refractive inorganic compound whose primary particles has an average diameter of 1 nm to 150 nm, such as silicon dioxide (silica) and fluorine containing particles (magnesium fluoride, calcium fluoride, and barium fluoride), and which may be organic fine particles (described in Japanese Patent Publication Laid-Open No. 11-3820, the specification, paragraphs [0020] to [0038]; the coupling agent; lubricant; and surfactant.

When the low refractive layer is formed as an outermost layer, the low refractive layer may be formed by a vapor phase method such as vacuum deposition method, sputtering method, ion plating method, and plasma CVD method. In view of cost, a coating method is preferable.

The thickness of the low refractive layer is preferably 30 nm to 200 nm, more preferably 50 nm to 150 nm, and most preferably, 60 nm to 120 nm.

[Hard Coat Layer]

To impart physical strength to the anti-reflective film, a hard coat layer is provided on the surface of drawn/undrawn cellulose acylate film. In particular, the hard layer is preferably provided between the drawn/undrawn cellulose acylate film and high refractive layer. Alternatively, in place of providing the anti-reflective layer, hard coat layer may preferably be directly coated on the drawn/undrawn cellulose acylate film

The hard coat layer is preferably formed by a crosslinking reaction of a photosetting and/or thermosetting compound or a polymerization reaction. As a

As the low refractive layer, a sol-gel hardened film is preferable. The sol-gel hardened film is formed by hardening an organic metal compound such as a silane coupling agent and a silane coupling agent containing a predetermined fluorine containing hydrocarbon group in the presence of a catalyst through a condensation reaction. For example, mention may be made of silane compounds containing a polyfluoroalkyl group or its partial hydrolysis condensation products (described in Japanese Patent Application Laid-Open Nos. 58-142958, 58-147483, 58-147484, 9-157582, 11-106704), and silyl compounds containing a poly[perfluoroalkylether] group, which is a long-chain group containing fluorine (described in Japanese Patent Application Laid-Open Nos. 2000-117902, 2001-48590, and 2002-53804).

The low refractive layer may contain, other than the aforementioned additives, additives including a filler, which may be a low-refractive inorganic compound whose primary particles has an average diameter of 1 nm to 150 nm, such as silicon dioxide (silica) and fluorine containing particles (magnesium fluoride, calcium fluoride, and barium fluoride), and which may be organic fine particles (described in Japanese Patent Application Laid-Open No. 11-3820, the specification, paragraphs [0020] to [0038]; silane coupling agent; lubricant; and surfactant.

When the low refractive layer is formed as an outermost layer, the low refractive layer may be formed by a vapor phase method such as vacuum deposition method, sputtering method, ion plating method, and plasma CVD method. In view of cost, a coating method is preferable.

The thickness of the low refractive layer is preferably 30 nm to 200 nm, more preferably 50 nm to 150 nm, and most preferably, 60 nm to 120 nm.

[Hard Coat Layer]

To impart physical strength to the anti-reflective film, a hard coat layer is provided on the surface of drawn/undrawn cellulose acylate film. In particular, the hard coat layer is preferably provided between the drawn/undrawn cellulose acylate film and the high refractive layer. Alternatively, in place of providing the anti-reflective layer, the hard coat layer may preferably be directly coated on the drawn/undrawn cellulose acylate film

The hard coat layer is preferably formed by a crosslinking reaction of a photosetting and/or thermosetting compound or a polymerization reaction. As a hardenable functional group, photo-polymerizable functional group is preferable. As an organic metal compound containing a hydrolysable functional group, an organic alkoxysilyl compound is preferable.

Examples of these compounds may include those exemplified regarding the high refractive layer.

Specific examples of the compositions for the hard coat layer, are described in Japanese Patent Application Laid-Open Nos. 2002-144913 and 2000-9908, and WO00/46617.

The high refractive layer may serve as the hard coat layer. In this case, the high refractive layer is preferably formed by minutely dispersing fine particles by use of a method described regarding high refractive layer.

The hard coat layer may serve also as an anti-glare layer (described later) by introducing particles of 0.2 μm to 10 μm in average size therein to impart anti-glare properties.

The thickness of the hard coat layer may be appropriately controlled depending upon the use. The thickness of the hard coat layer is preferably 0.2 μm to 10 μm, and more preferably 0.5 μm to 7 μm.

The strength of the hard coat layer is preferably “1H” or more based on the pensile hardness test according to JIS K5400, more preferably “2H” or more, and most preferably “3H” or more. Also, a test piece of the hard coat layer is preferably produces a low amount of abrasion powder in the taper test according to JIS K5400.

[Forward Scattering Layer]

The front scatting layer, when applied to the liquid crystal display device, is provided to improve a viewing angle when the display is seen in various angles (up and down, right and left). The forward scattering layer may serve as the hard coat layer by dispersing fine particles having different refractive indexes in the hard coat layer.

In connection with the forward scattering layer, the forward scattering coefficient is specified in Japanese Patent Application Laid-Open No. 11-38208. A transparent resin and the range of the relative refractive index of and fine particles are specified in Japanese Patent Application Laid-Open No. 2000-199809. The haze value is defined as 40% or more in Japanese Patent Application Laid-Open No. 2002-107512.

[Other Layers]

Other than the aforementioned layers, a primer layer, antistatic layer, undercoating layer, and protecting layer may be provided.

[Coating Method]

Individual layers of the anti-reflective film may be formed by a coating method. Examples of the coating method included dip-coating method, air-knife method, curtain coating method, roller coating method, wire-bar coating method, gravure coating method, micro-gravure coating method and extrusion coating method (U.S. Pat. No. 2,681,294).

[Antiglare Function]

The anti-reflective film may have an antiglare function, which is a function of scattering incident light. The antiglare function can be produced by forming concave-convex portions on the surface of the anti-reflective film. When the anti-reflective film has an antiglare function, the haze of the anti-reflective film is preferably 3% to 30%, more preferably 5% to 20%, and most preferably, 7% to 20%.

As a method of forming concave-convex portions in the surface of the anti-reflective film, any method may be used as long as it can sufficiently maintain these concave-convex portions. Examples of such a method for forming the convex-concave portions in the film surface are:

adding fine particles to a low refractive layer (e.g., Japanese Patent Application Laid-Open No. 2000-271878);
adding relative large particles (particle size of 0.05 μm to 2 μm) in the underlying layer of a low refractive layer (that is, a high refractive layer, medium refractive layer or hard coat layer) to produce a convexoconcave underlying layer, followed by forming the low refractive layer so as to keep concave-convex portions (e.g., Japanese Patent. Application Laid-Open Nos. 2000-281410, 2000-95893, 2001-100004 and 2001-281407); transferring concave-convex portions physically onto the surface of the outermost layer (antifouling layer) after the outermost layer is formed (e.g., embossment is described in Japanese Patent Application Laid-Open Nos. 63-278839, 11-183710 and 2000-275401).

[Usage]

An undrawn/drawn cellulose acylate film according to the present invention is useful as optical film, in particular, protective film for a polarizer, optical compensation sheet for a liquid crystal display device (phase difference film), an optical compensation sheet of a reflective liquid crystal display device, and a substrate for a silver halide photosensitive material.

(1) Preparation of Polarizer

(1-1) Drawing

An undrawn cellulose acylate film is drawn at a glass transition temperature (Tg) of the film+10° C. at a draw ratio of 300%/minute. Examples of the drawn film include

(1) a film having Re of 200 nm and Rth of 100 nm by drawing an undrawn film at a longitudinal draw ratio of 300% and a transverse draw ratio of 0%;
(2) a film having Re of 60 nm and Rth of 220 nm by drawing an undrawn film at a longitudinal draw ratio of 50% and a transverse draw ratio of 10%;
(3) a film having Re of 0 nm and Rth of 450 nm by drawing an undrawn film at a longitudinal draw ratio of 50% and a transverse draw ratio of 50%;
(4) a film having Re of 60 nm and Rth of 220 by drawing an undrawn film at a longitudinal draw ratio of 50% and a transverse draw ratio of 10%; and
(5) a film having Re of 150 nm and Rth of 150 nm by drawing an undrawn film at a longitudinal draw ratio of 0% and a transverse draw ratio of 150%.

(1-2) Saponification of Cellulose Acylate Film

An undrawn/drawn cellulose acylate film is saponificated by soaking. Even if the film is saponificated by coating, the same results can be obtained.

(i) Saponification by Soaking

A 1.5N aqueous NaOH solution is used as a saponification solution. A cellulose acylate film is soaked in the solution controlled at 60° C. for 2 minutes. Thereafter, it is soaked in a 0.1N aqueous sulfuric acid solution for 30 seconds and transferred to a water bath.

(ii) Saponification by Coating

20 parts by mass of water is added to 80 parts by mass of iso-propanol. To this mixture, KOH is dissolved up to a concentration of 1.5 N. The resultant mixture controlled in temperature at 60° C. is used as a saponification solution. This saponification solution is applied onto a cellulose acylate film in a ratio of 10 g/m to saponificate the film for one minute. Thereafter, warm water of 50° C. is sprayed onto the film at a rate of 10 L/m²/minute to wash it.

(1-3) Preparation of a Polarizing Layer

According to Example 1 of Japanese Patent Application Laid-Open No. 2001-141926, a film is drawn in the longitudinal direction by rotating two pairs of nip rolls at different rotation speeds (peripheral speed) to prepare a polarizing layer of 20 μm in thickness.

(1-4) Adhesion

The polarizing layer thus prepared and the undrawn/drawn cellulose acylate film saponificated above are adhered by use of a 3% aqueous PVA (PVA-117H manufactured by Kraray. Co., Ltd.) solution as an adhesive agent such that the polarizing axis and the longitudinal direction of the cellulose acylate film forms an angle of 45° C. The polarizer thus prepared is integrated in a 20 inch VA type liquid crystal display device shown in FIGS. 2 to 9 of Japanese Patent Application Laid-Open No. 2000-154261. Good performance can be obtained by observing the display diagonally with an angle of 32° at which projected parallel streams can be most easily observed.

(2) Preparation of Optical Compensation Film

(i) Undrawn Film

A good optical compensation film can be obtained by using an undrawn cellulose acylate film according to the present invention as the first transparent substrate according to Example 1 of Japanese Patent Application Laid-Open No. 11-316378.

(ii) Drawn Cellulose Acylate Film

A good optical compensation film can be obtained by using a drawn cellulose acylate film according to the present invention in place of the cellulose acetate film coated with a liquid crystal layer according to Example 1 of Japanese Patent Application Laid-Open No. 11-316378. A good optical compensation film, that is, an optical compensation filter film (optical compensation film B), can be obtained by using a drawn cellulose acylate film according to the present invention in place of the cellulose acetate film coated with a liquid crystal layer according to Example 1 of Japanese Patent Application Laid-Open No. 7-333433.

(3) Preparation of Low Reflective Film

A low reflective film having good optical properties can be obtained by using a drawn/undrawn cellulose acylate film of the present invention in accordance with Example 47 of Technical Report No. 2001-1745 by the Japan Institution of Invention.

(4) Preparation of Liquid Crystal Display Device

A polarizer according to the present invention is used in a liquid crystal display device according to Example 1 of Japanese Patent Application Laid-Open No. 10-48420; in an optical anisotropic layer containing discotic liquid crystal molecules according to Example 1 of Japanese Patent Application Laid-Open No. 9-26572; in orientation film coated with polyvinyl alcohol; in a 20 inch VA type liquid crystal display device according to FIGS. 2 to 9 of Japanese Patent Application Laid-Open No. 2000-154261; and a 20 inch OCB type liquid crystal display device according to FIGS. 10 to 15 of Japanese Patent Application Laid-Open No. 2000-154261. Furthermore, a low reflective film according to the present invention is adhered onto the outermost surface layer of these liquid crystal display devices to obtain good visual observation.

### EXAMPLES

The present invention will be more specifically explained by way of Examples: Experiments 1 to 18, below. Details of Examples will be explained in Experiment 1. The different conditions of Experiments 2 to 18 from those of Experiment 1 will be summarized in Tables 1 to 4. The materials, amounts, ratios, treatments, and procedures shown in the following Examples may appropriately changed within the gist of the present invention. Accordingly, Examples will not be construed as limiting the scope of the present invention.

(1) Synthesis of Cellulose Acylate (Cellulose Acetate Propionate)

80 parts by mass of cellulose (broad-leave pulp) and 33 parts by mass of acetic acid were placed in a reaction vessel equipped with a cooling apparatus and a reflux apparatus, and stirred for 4 hours while heating at 60° C. Thereafter, the reaction vessel was cooled to 2° C.

Separately, a mixture of 33 parts by mass of acetic anhydride serving as an acylating agent, 518 parts by mass of propionic acid, 537 parts by mass of propionic anhydride and 3.2 parts by mass of sulfuric acid was prepared. The mixture was cooled to −20° C. and added to the reaction vessel containing cellulose prepared above at a time. After 30 minutes, the exterior temperature of the reaction vessel was gradually increased so as to set the inner temperature of the reaction vessel at 30° C. in 1.5 hours after addition of an acylate agent. While maintaining the inner temperature of the vessel at 30° C., the reaction mixture was continued to stir. When the viscosity of the reaction mixture reached 0.8N·s·m⁻² (=8P=800 cp), the reaction vessel was cooled until the inner temperature became 12° C.

Thereafter, 266 g of acetic acid containing 50% by mass of water and cooled to 5° C. was added to the reaction vessel while keeping the inner temperature of 25° C. or less. The inner temperature of the reaction vessel was increased to 60° C. and the reaction mixture was stirred for 1.5 hours. Subsequently, a solution containing magnesium acetate 4 hydrates (corresponding to 2-fold mol of acetic acid) that was dissolved in 2 fold acetic acid containing 50% by mass of water, was added to the reaction vessel and the mixture was stirred for one hour.

An aqueous acetic acid solution was added to the resultant mixture while increasing the water content thereof. Further water was added to the reaction mixture to permit cellulose acetate propionate to precipitate. The obtained precipitation of cellulose acetate propionate was washed with warm water, added to a 0.001% by mass aqueous calcium hydroxide solution (20° C.) and stirred for 0.5 hours. After liquid (water) was removed from the reaction mixture, the resultant product was dried at 70° C. in vacuum.

The obtained cellulose acetate propionate was measured by ¹H-NMR and GPC. As a result, it had an acetylation degree of 0.32, propionation degree of 2.55, number average molecular weight (Mn) of 48,000 and a weight average molecular weight of 150,000, and a glass transition temperature (Tg) of 120° C.

### Synthesis Example 2

Ten parts by mass of cellulose (broadleaf pulp) was sprayed with 0.1 parts by mass of acetic acid and 2.7 parts by mass of propionic acid and kept at room temperature for 1 hour. Separately, a mixture was prepared of 1.2 parts by mass of acetic anhydride, 61 parts by mass of propionic anhydride and 0.7 parts by mass of sulfuric acid, and after cooling to −10° C., the mixture was mixed with the above pretreated cellulose in a reactor.

After an elapse of 30 minutes, the external temperature was raised to 30° C. to allow reaction to proceed for 4 hours. To the reactor, 46 parts by mass of 25% hydrous acetic acid was added, and after raising the internal temperature of the reactor to 60° C., the mixture was stirred for 2 hours. Then 6.2 parts by mass of a solution, which was prepared by mixing the same amount of magnesium acetate tetrahydrate, acetic acid and water, was added and stirred for 30 minutes (neutralization step). The reaction solution was pressure filtered through sintered metallic filters (two-step filtration using filters with particle retention of 40 μm and 10 μm) to remove contaminants. The reaction solution after filtration was mixed with 75% hydrous acetic acid to precipitate cellulose acetate propionate, and the precipitated cellulose acetate propionate was washed with hot water at 70° C. until the pH of the washing solution became 6 to 7. Further, the cellulose acetate propionate was put in a 0.001% aqueous solution of calcium hydroxide and subjected to stirring treatment for 0.5 hours, then and the solution was filtered. The resultant cellulose acetate propionate was dried at 70° C. The ¹H-NMR measurements revealed that in the resultant cellulose acetate propionate, the degree of acetylation was 0.15, the degree of propionylation was 2.62, the degree of the total acylation was 2.77, the number average molecular weight was 54500 (the number average polymerization degree DPn=173), the mass average molecular weight was 132000 (the mass average polymerization degree DPw=419), the amount of the residual sulfuric acid was 45 ppm, the magnesium content was 8 ppm, the calcium content was 46 ppm, the sodium content was 1 ppm, the potassium content was 1 ppm and the iron content was 2 ppm. The observation, by a polarizing microscope, of the cast film formed from a solution of the cellulose acylate propionate sample in dichloromethane showed almost no contaminant either when the two sheets of polarizer were made perpendicular to each other or when they were made parallel to each other.

[Experiments 2 to 17]

In Experiments 2 to 15, cellulose acylate different in acetylation degree, propionation degree, butyration degree, and polymerization degree were synthesized by adjusting an acylating agent in Synthesis Example 1. In Experiments 16 and 17, cellulose acylate was synthesized in accordance with Synthesis Example 2. Note that the cellulose acetate propionate and cellulose acetate butyrate propionate of these experiments were collectively called as CAP. The acetylation degree, propionation degree, butyration degree and polymerization degree of CAP products are collectively shown in Table 1.

TABLE 1

| | Substitution degree of cellulose acylate | | | | | | |
|---|---|---|---|---|---|---|---|
| | | Propionate | | | | Number average | Glass transition |
| | Acetate group | group | Butyryl group | B (Total of B1 + | | molecular weight | temperature |
| | A | B1 | B2 | B2) | A + B | Mn | Tg ° C. |
| Experiment 1 | 0.32 | 2.55 | | 2.5 | 2.87 | 48,000 | 120 |
| Experiment 2 | 0.25 | 2.5 | 0.15 | 2.65 | 2.9 | 46,000 | 118 |
| Experiment 3 | 0.25 | 2.5 | 0.15 | 2.65 | 2.9 | 46,000 | 118 |
| Experiment 4 | 0.32 | 2.55 | | 2.55 | 2.87 | 48,000 | 120 |
| Experiment 5 | 0.32 | 2.55 | | 2.55 | 2.87 | 48,000 | 120 |
| Experiment 6 | 0.32 | 2.55 | | 2.55 | 2.87 | 48,000 | 120 |
| Experiment 7 | 0.32 | 2.55 | | 2.55 | 2.87 | 48,000 | 120 |
| Experiment 8 | 0.25 | 2.5 | 0.15 | 2.65 | 2.9 | 46,000 | 118 |
| Experiment 9 | 0.32 | 2.55 | | 2.55 | 2.87 | 48,000 | 120 |
| Experiment 10 | 0.32 | 2.55 | | 2.55 | 2.87 | 48,000 | 120 |
| Experiment 11 | 0.32 | 2.55 | | 2.55 | 2.87 | 48,000 | 120 |
| Experiment 12 | 0.32 | 2.55 | | 2.55 | 2.87 | 48,000 | 120 |
| Experiment 13 | 0.32 | 2.55 | | 2.55 | 2.87 | 48,000 | 120 |
| Experiment 14 | 0.3 | 2.55 | | 2.55 | 2.85 | 48,000 | 135 |
| Experiment 15 | 0.3 | 2.55 | | 2.55 | 2.85 | 48,000 | 135 |
| Experiment 16 | 0.15 | 2.62 | | 2.62 | 2.77 | 5.45 | 133 |
| Experiment 17 | 0.15 | 2.62 | | 2.62 | 2.77 | 5.45 | 133 |

(2) Pelletization of CAP

CAP pellets were prepared by adding the following additives to CAP.

| | |
|---|---|
| CAP | 100 parts by mass |
| Plasticizer: glycerin diacetate strearate | 5 parts by mass |
| Stabilizer: triphenyl phosphite (TPP) | 0.3 parts by mass |
| Matting agent: Silicon dioxide particles (aerosol R972V) | 0.05 parts by mass |
| UV absorbent: (2-2′-hydroxy-3′5-di-t-butylphenyl)-benzotriazole | 0.5 parts by mass |
| UV absorbent: 2,4-hydroxy-4-methoxy-benzophenone | 0.1 part by mass |

The mixture was dried at 100° C. for 3 hours to a water content of 0.1% or less (by mass).

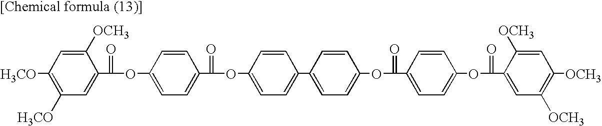

The compound described above was placed in a double screw extruder (kneader) equipped with an exhauster, kneaded at a screw-rotation number of 300 rpm for 40 seconds and extruded from a die at a rate of 200 kg/hr into water of 60° C. to solidify therein. The solidified product was cut into cylindrical pellets (CAP pellets) of 2 mm in diameter and 3 mm in length. The glass transition temperature (Tg) of CAP pellets was 120° C.

(3) Melt Film Formation

CAP pellets were dried at dewatered air (having a dew point of −40° C.) at 100° C. for 5 hours up to a water content of 0.01% or less (by mass). The dried CAP pellets were placed in a hopper of 80° C. and supplied to an extruder 11, which has a screw having a diameter (viewing from the outlet) of 60 mm, L/D ratio of 50, a compression ratio of 4. A screw was cooled by circulating oil (oil temperature: Tg of the pellets −5° C. (about 115° C.)) into a portion of the screw at a distance of 250 mm from the inlet of the extruder. The CAP pellets were controlled to stay in the barrel of the extruder for 5 minutes. The maximum temperature and the minimum temperature of the barrel were controlled so as to correspond to the temperatures of the outlet and inlet of the barrel, respectively. Hereinafter, CAP pellets melted within the extruder 11 will be referred to as “Molten CAP.” The molten CAP extruded from the extruder 11 and measured into portions of a regular amount by the gear pump 12 and fed toward a die. The rotation number of the extruder 11 was controlled such that the pressure of the molten CAP upstream of the gear pump 12 was always set at a value of 10 Mpa. Molten CAP fed from the gear pump 12 was filtrated by a leaf-disk filter having a filtration accuracy of 5 μm and passed through a static mixer and fed into a hanger coat die 14. Then, the molten CAP was extruded from the slit (0.8 mm) of the hanger coat die 14 in the form of sheet (hereinafter referred to as “sheet-form CAP 41”). Note that the temperature of the hanger coat die 14 was adjusted at 240° C. The film-thickness of the sheet from CAP 41 extruded from the hanger coat die 14 was controlled so as to be 80 μm. The resultant cellulose acylate film showed crystallizability, and in its differential scanning calorimetry (DSC), an endothermic peak due to crystalline melting appeared in the temperature range of 170° C. to 240° C. The crystalline melting point is preferably 7 J/g or higher and 20 J/g or lower.

The casting drum 17 (referred as a “second roll” or “rigid roll” in Table 2) having a surface roughness of 25 nm was used. The temperature of the casting drum 17 was adjusted at 120° C. As the elastic drum (referred to as first roll, elastic roll in Table 2) 18, a drum was used which had a surface roughness of 25 nm and whose outer cylinder had a thickness Z of 1.5 mm. The roll temperature of the elastic drum 18 was adjusted to 120° C. The line speed (≈film forming speed) of the manufacturing line was 30 m/minute, and the film forming conditions were adjusted so that the resultant CAP film 42 had a thickness of 80 μm.

As shown in FIG. 2, the arrangement of the casting drum 17 and the elastic drum 18 was adjusted so that the roll contact length Q was 1.6 cm and the roll line pressure P was 100 kg/cm. The roll contact length Q (cm) was determined by measuring the length of the CAP sheet 41 in contact the elastic drum 18 with a prescale. The roll line pressure P (kg/cm) was obtained by dividing the total pressure, which was obtained by setting an air cylinder that pressed both drums, by the pressing width. In this case, the ratio (=P/Q) was 62.50. The roll temperatures of the cooling drums 19, 20 were adjusted to 120° C., 120° C., respectively with the cooling unit 25. A film was manufactured by so-called touch roll method in which the CAP sheet 41 was cast between the casting drum 17 and the elastic drum 18.

The sheet-form CAP 41 was cooled to solidify to obtain a CAP film 42 (hereinafter referred to as an “undrawn CAP film”). The obtained undrawn CAP film 42 was trimmed at the edges (each corresponding to 5% of the whole width of the film) immediately before rolling up. Thereafter, knurling (10 mm in width, 50 μm in height) was provided to both edges and rolled up by a roll 24 to obtain a roll (1.5 m in width, 3000 m in length).

[Experiments 2 to 17]

Experiments 2 to 17 were performed in the same manner as in Experiment 1 except for the conditions described in Tables 2 and 3.

TABLE 2

| | Conditions of cooling roll | | | | | | |
|---|---|---|---|---|---|---|---|
| | First roll | | | Second roll | | | |
| | (Elastic roll) | | | (Rigid roll) | | | |
| | Surface | Thickness of | Temperature | Surface | Temperature | | |
| | roughness | outer cylinder | of roll | roughness | of roll | Line speed | Film-thickness |
| | nm | mm | ° C. | nm | ° C. | m/min | μm |
| Experiment 1 | 25 | 1.5 | 120 | 25 | 120 | 20 | 80 |
| Experiment 2 | 25 | 1.5 | 116 | 25 | 116 | 30 | 80 |
| Experiment 3 | 50 | 1.8 | 116 | 50 | 116 | 20 | 80 |
| Experiment 4 | 25 | 1.5 | 90 | 25 | 90 | 50 | 80 |
| Experiment 5 | 25 | 1.5 | 60 | 25 | 60 | 70 | 80 |
| Experiment 6 | 25 | 2.5 | 120 | 25 | 120 | 15 | 80 |
| Experiment 7 | 25 | 1.8 | 115 | 25 | 120 | 40 | 80 |
| Experiment 8 | 25 | 1.5 | 90 | 25 | 90 | 55 | 80 |
| Experiment 9 | 25 | 1.5 | 120 | 150 | 120 | 20 | 80 |
| Experiment 10 | 25 | 1.5 | 90 | 25 | 90 | 4 | 80 |
| Experiment 11 | 25 | 1.5 | 60 | 25 | 60 | 10 | 80 |
| Experiment 12 | 25 | 15 | 120 | 25 | 120 | 15 | 80 |
| Experiment 13 | 25 | 0.1 | 120 | 25 | 120 | 10 | 80 |
| Experiment 14 | 25 | 2 | 130 | 25 | 130 | 20 | 80 |
| Experiment 15 | 25 | 2.5 | 130 | 25 | 130 | 20 | 80 |
| Experiment 16 | 25 | 2 | 130 | 25 | 130 | 20 | 80 |
| Experiment 17 | 25 | 2.5 | 130 | 25 | 130 | 20 | 80 |

TABLE 3

| | Film formation conditions | | |
|---|---|---|---|
| | Roll-contact | Roll-line | |
| | length | pressure | P/Q |
| | Q cm | P kg/cm | kg/cm² |
| Experiment 1 | 1.6 | 100 | 62.50 |
| Experiment 2 | 1.5 | 90 | 60.00 |
| Experiment 3 | 1.4 | 100 | 71.43 |
| Experiment 4 | 1.7 | 100 | 58.82 |
| Experiment 5 | 1.7 | 100 | 58.82 |
| Experiment 6 | 1.3 | 100 | 76.92 |
| Experiment 7 | 1.5 | 110 | 73.33 |
| Experiment 8 | 1.6 | 120 | 75.00 |
| Experiment 9 | 1.7 | 100 | 58.82 |
| Experiment 10 | 1.7 | 100 | 58.82 |
| Experiment 11 | 1.7 | 100 | 58.82 |
| Experiment 12 | 0.3 | 120 | 400.00 |
| Experiment 13 | 3 | 5 | 1.67 |
| Experiment 14 | 1.1 | 100 | 90.91 |
| Experiment 15 | 0.8 | 100 | 125.00 |
| Experiment 16 | 1.1 | 100 | 90.91 |
| Experiment 17 | 0.8 | 100 | 125.00 |

(4) Evaluation of Undrawn CAP Film

An undrawn CAP film produced from CAP obtained in each of the Experiments was evaluated for retardation (Re and Rth), damages such as stripe, smoothness of film, and haze. The measurement and evaluation results are collectively shown in Table 4. The films were integrally evaluated based on these measurement and evaluation results.

(i) Retardation Values (Re and Rth)

Samples were taken from 10 points of the undrawn CAP film at the same intervals. The samples were conditioned at 25° C. and a relative humidity of 60% for 4 hours, phase contrast was measured at 25° C. and a relative humidity of 60% by an automatic birefringence analyzer (KOBRA-21ADH manufactured by Oji Scientific Instrument) when light having a wavelength of 590 nm was applied. More specifically, the phase contrast was measured by in the vertical direction of the sample film surface and in the directions around the delayed axis as a rotation center, more specifically, in the directions having angles with the normal line to the film surface within the range of +50° to −50° (actually, measurement was performed at intervals of 10° within the range).

(ii) Observation of Stripe

The appearance of the undrawn CAP films obtained was visually observed. A sample having no stripe was indicated by “G”; a sample having minor stripe but no practical problem by “M”; a sample having minor stripe and a practical problem by “P”; and a sample having apparent stripe by “PP.”

(iii) Measurement of Haze

The haze of the undrawn CAP films was measured by a turbidimeter NDH-1001DP (manufactured by Japan Denshoku Industries Co., Ltd.).

(iv) Integrated Evaluation

Films were integrally evaluated based on the following four levels in consideration of individual evaluation results above.

◯: Quite excellent in optical characteristics and mechanical strength; Δ: Excellent in optical characteristics and mechanical strength;

X: Shortage was observed in optical characteristics and mechanical strength and cannot be used as a product.

TABLE 4

| | | | Rth | | | | |
|---|---|---|---|---|---|---|---|
| | Re | | | Charge | Damage | | Integrated |
| | (nm) | Change rate % | (nm) | rate % | of stripe | Haze % | evaluation |
| Experiment 1 | 0.9 | 1 | 40.2 | 1 | ◯ | 0.3 | ◯ |
| Experiment 2 | 0.7 | 1 | 32.3 | 0.5 | ◯ | 0.4 | ◯ |
| Experiment 3 | 0.8 | 1 | 36.2 | 0.5 | ◯ | 1.1 | ◯ |
| Experiment 4 | 0.6 | 1 | 38.8 | 1 | ◯ | 0.4 | ◯ |
| Experiment 5 | 1 | 1 | 36.8 | 1 | ◯ | 0.3 | ◯ |
| Experiment 6 | 1.8 | 1 | 43.5 | 1 | ◯ | 0.3 | ◯ |
| Experiment 7 | 1 | 1 | 39.2 | 1 | ◯ | 0.3 | ◯ |
| Experiment 8 | 0.7 | 1 | 39.8 | 0.5 | ◯ | 0.3 | ◯ |
| Experiment 9 | 1 | 1 | 29.3 | 1 | ◯ | 3.5 | Δ |
| Experiment 10 | 21.2 | 2 | 31.3 | 2 | ◯ | 0.3 | Δ |
| Experiment 11 | 35.2 | 1 | 67.1 | 1 | ◯ | 0.3 | Δ |
| Experiment 12 | 53 | 1 | 88.9 | 1 | ◯ | 0.3 | X |
| Experiment 13 | 0.2 | 1 | 0.7 | 1 | Δ | 0.3 | X |
| Experiment 14 | 2.1 | 1 | 105 | 2 | ◯ | 0.3 | ◯ |
| Experiment 15 | 3.3 | 1 | 156 | 2 | ◯ | 0.3 | ◯ |
| Experiment 16 | 3.4 | 1 | 95 | 2 | ◯ | 0.3 | ◯ |
| Experiment 17 | 3.8 | 1 | 146 | 2 | ◯ | 0.3 | ◯ |

The results revealed that the films obtained in Experiments 1 to 11 and 14 to 17 in which the elastic drum (first roll) 18 of the present invention was used, had the desired thickness-direction retardation (Rth.)

1. A method for manufacturing a thermoplastic resin film, comprising the steps of:
extruding a molten thermoplastic resin from a die in the form of sheet; and
sandwiching the sheet-form thermoplastic resin between one support and the other support to cool the supports,
wherein at least one of the supports has such a surface property that the arithmetic average surface depth (Ra) is 100 nm or less, and
the support is a hollow drum and the thickness Z (mm) of an outer cylinder of the drum satisfies the following expression;
0.2 mm<Z (mm)<7.0 mm.

2. The method for manufacturing a thermoplastic resin film according to claim 1,
wherein the ratio (P/Q) of the line pressure P (kg/cm) of the sheet-form thermoplastic resin sandwiched between the one drum and the other drum and the length Q (cm) of the one support in contact with the other support via the sheet-form thermoplastic resin interposed therebetween satisfies
50 kg/cm²<(P/Q)<200 kg/cm².

3. The method for manufacturing a thermoplastic resin film according to claim 1, wherein a manufacturing speed Y (m/min) of the thermoplastic resin film satisfies the following equation:
0.0043X²+0.1236X+1.1357<Y (m/min)<0.0191X²+0.7316X+24.005;
where T1 (° C.) represents the solid-solid phase transition temperature of the thermoplastic resin, T2 (° C.) represents the temperature of at least one of the supports, and X(° C.) represents (T1−T2), which is a temperature difference between T1 and T2.

4. The method for manufacturing a thermoplastic resin film according to of claim 3, wherein the solid-solid phase transition temperature (° C.) of the thermoplastic resin is equal to the glass transition temperature Tg (° C.) of the thermoplastic resin.

5. The method for manufacturing a thermoplastic resin film according to claim 1, wherein the length Q (cm) of the one support in contact with the other support via the sheet-form thermoplastic resin is 0.5 cm to 2.5 cm (both inclusive).

6. The method for manufacturing a thermoplastic resin film according to claim 1, wherein the temperature T0 (° C.) of the sheet-form thermoplastic resin before it is sandwiched between the one support and the other support is 45° C. to 160° C. (both inclusive).

7. The method for manufacturing a thermoplastic resin film according to claim 1, wherein at least one of the supports is an elastic roll made of a metal.

8. The method for manufacturing a thermoplastic resin film according to claim 1, wherein the thermoplastic resin is a cellulose acylate resin.

9. The method for manufacturing a thermoplastic resin film according to claim 8, wherein the cellulose acylate resin has a number average molecular weight of 20,000 to 80,000 and the substitutions degree of the acyl groups satisfies following equations:
2.0≦A+B≦3.0,
0≦A≦2.0,
1.2≦B≦2.9,
where A represents the substitution degree of acetyl groups and B represents the sum of substitution degrees of acyl groups having 3 to 7 carbon atoms.

10. The method for manufacturing a thermoplastic resin film according to claim 1, wherein the temperature of at least one of the supports is adjusted to 45° C. to 160° C. (both inclusive).

11. The method for manufacturing a thermoplastic resin film according to claim 1, wherein at least one of the supports is a roll or a belt.

12. The method for manufacturing a thermoplastic resin film according to claim 1, wherein a zero shear viscosity of the thermoplastic resin ejected from the die is 2000 Pa·s or less.

13. The method for manufacturing a thermoplastic resin film according to claim 1, wherein the zero shear viscosity of the thermoplastic resin at 230° C. measured by plate-cone viscometry is 50 Pa·s to 2000 Pa·s (both inclusive).

14. The method for manufacturing a thermoplastic resin film according to claim 1, wherein the in-plane retardation (Re) of the thermoplastic resin film is 20 nm or smaller.

15. The method for manufacturing a thermoplastic resin film according to claim 1, wherein the thermoplastic resin film has a thickness-direction retardation (Rth) of 20 nm to 200 nm (both inclusive).

16. The method for manufacturing a thermoplastic resin film according to claim 1, further comprising a drawing step in which the sheet-form thermoplastic resin or thermoplastic resin film is drawn in an arbitrary direction.

17. The method for manufacturing a thermoplastic resin film according to claim 1, wherein the thermoplastic resin serving as a substrate of an optical compensation film is manufactured.

18. The method for manufacturing a thermoplastic resin film according to claim 1, wherein the thermoplastic resin serving as a substrate of a polarizing film of a sheet polarizer is manufactured.

19. The method for manufacturing a thermoplastic resin film according to claim 1, wherein the thermoplastic resin film serving as a substrate of an anti-reflective film is manufactured.
